(19) United States
(12) Patent Application Publication
(10) Pub. No.: US 2026/0029678 A1
(43) Pub. Date: Jan. 29, 2026

(54) DISPLAY SUBSTRATE, DISPLAY MOTHERBOARD, DISPLAY PANEL AND DISPLAY DEVICE

(71) Applicants: WUHAN BOE OPTOELECTRONICS TECHNOLOGY CO., LTD., Wuhan (CN); BOE TECHNOLOGY GROUP CO., LTD., Beijing (CN)

(72) Inventors: Jing Wang, Beijing (CN); Zhi Yang, Beijing (CN); Shi Cheng, Beijing (CN); Zimo Sheng, Beijing (CN); Jun Feng, Beijing (CN); Bin Xie, Beijing (CN); Xiangyu Gao, Beijing (CN); Junjie Fu, Beijing (CN); Kun Guo, Beijing (CN); Xinxin Zhao, Beijing (CN)

(21) Appl. No.: 18/995,136

(22) PCT Filed: May 14, 2024
(86) PCT No.: PCT/CN2024/093188

§ 371 Date: Jan. 15, 2025

(30) Foreign Application Priority Data
Jun. 30, 2023 (CN) 202310804260.3

(51) Int. Cl. G02F 1/1362; G09G 3/36

(52) U.S. Cl. CPC G02F 1/136204; G02F 1/136295; G09G 3/3677; G09G 2300/0819; G09G 2330/06

(57) ABSTRACT

Provided is a display substrate, including: a base substrate; a gate driving circuit; first signal lines in a side region, a first corner region and a second corner region. The first signal lines include an initiation signal line and an initiation signal lead on a side of the initiation signal line close to the gate driving circuit, and the two extend in a second direction and are electrically connected through a first connecting line in the second corner region. First signal lines are provided with an anti-static structure in at least one of first position and second position, the first position includes a connection between the initiation signal line, initiation signal lead and the first connecting line, and the second position includes a portion of the first signal lines on a side of a row where a first-stage shift register unit is located close to the binding opposite region.

### CROSS REFERENCE TO RELATED APPLICATION

This application is a Section 371 National Stage Application of International Application No. PCT/CN2024/093188 filed on May 14, 2024, which claims priority to Chinese Patent Application No. 202310804260.3 filed on Jun. 30, 2023, which are incorporated herein by reference in their entirety.

### TECHNICAL FIELD

The present disclosure relates to the field of display technology, and in particular, to a display substrate, a display motherboard, a display panel and a display device.

### BACKGROUND

At present, through masking exposure and partial exposure processes, a mask pattern may be multiplexed to expose display substrate regions having different sizes on one and same display motherboard, so that display substrates having different sizes may be simultaneously formed on the display motherboard. In this way, it is possible to save research and development costs of masks. However, a small-size display substrate obtained by this method may have missing anti-static units, resulting in a weak anti-static capability of the display substrate.

### SUMMARY

In view of the above problems, the present disclosure provides a display substrate, a display motherboard, a display panel and a display device.

According to a first aspect of the present disclosure, a display substrate is provided, including: a display region, a binding region, a binding opposite region, a side region, a first corner region and a second corner region, the side region and the display region are arranged in a first direction, the binding opposite region, the display region and the binding region are arranged in sequence in a second direction intersecting with the first direction, the first corner region is located between the side region and the binding opposite region and at least partially surrounds a first corner of the display region, and the second corner region is located between the side region and the binding region and at least partially surrounds a second corner of the display region; a base substrate; a gate driving circuit provided on the base substrate and located in the side region, the gate driving circuit includes multi-stage shift register units connected in cascade; a plurality of first signal lines provided on the base substrate and located in the side region, the first corner region and the second corner region. The plurality of first signal lines are located on a side of the gate driving circuit away from the display region; the plurality of first signal lines include an initiation signal line and an initiation signal lead, the initiation signal lead is located on a side of the initiation signal line close to the gate driving circuit, and the initiation signal line and the initiation signal lead extend in the second direction and are electrically connected through a first connecting line in the second corner region; and the plurality of first signal lines are provided with an anti-static structure in at least one of a first position and a second position, the first position includes a connection between the initiation signal line and the first connecting line and a connection between the initiation signal lead and the first connecting line, and the second position includes a portion of the plurality of first signal lines on a side of a row where a first-stage shift register unit is located close to the binding opposite region.

According to the embodiments of the present disclosure, the anti-static structure in the first position includes: a first welding structure configured to weld the initiation signal line and the first connecting line together at the connection between the initiation signal line and the first connecting line; and/or a second welding structure configured to weld the initiation signal lead and the first connecting line together at the connection between the initiation signal lead and the first connecting line.

According to the embodiments of the present disclosure, the display substrate includes a first conductive layer, a second conductive layer on a side of the first conductive layer away from the base substrate, and a third conductive layer on a side of the second conductive layer away from the second conductive layer; the display substrate further includes a first transfer structure in the third conductive layer, the initiation signal line is located in the first conductive layer, and the first connecting line is located in the second conductive layer; the initiation signal line includes a first connecting portion and a signal line body, an orthographic projection of the first connecting portion on the base substrate overlaps at least partially with an orthographic projection of the first transfer structure on the base substrate, and the first connecting portion is electrically connected to the first transfer structure in an overlapping region of the first connecting portion and the first transfer structure through at least one first via hole; an orthographic projection of the first connecting line on the base substrate overlaps at least partially with the orthographic projection of the first transfer structure on the base substrate, and the first connecting line is electrically connected to the first transfer structure in an overlapping region of the first connecting line and the first transfer structure through at least one second via hole; and an orthographic projection of the first welding structure on the base substrate overlaps partially with the orthographic projection of the first connecting portion on the base substrate, an orthographic projection of the signal line body on the base substrate and the orthographic projection of the first connecting line on the base substrate, and the first welding structure is configured to weld the first connecting portion, the signal line body and the first connecting line together in an overlapping region of the first welding structure, the first connecting portion, the signal line body and the first connecting line.

According to the embodiments of the present disclosure, the first connecting line includes a second connecting portion and a connecting line body, an orthographic projection of the second connecting portion on the base substrate overlaps at least partially with the orthographic projection of the first transfer structure on the base substrate, and the second connecting portion is electrically connected to the first transfer structure in an overlapping region of the second connecting portion and the first transfer structure through the second via hole; and the first welding structure includes: a first welding portion, an orthographic projection of the first welding portion on the base substrate overlaps partially with the orthographic projection of the first connecting portion on the base substrate and an orthographic projection of the second connecting portion on the base substrate, and the first welding portion is configured to weld the first connecting portion and the second connecting portion together in an overlapping region of the first welding portion, the first connecting portion and the second connecting portion; and/or a second welding portion, an orthographic projection of the second welding portion on the base substrate overlaps partially with the orthographic projection of the signal line body on the base substrate and an orthographic projection of the connecting line body on the base substrate, and the second welding portion is configured to weld the signal line body and the connecting line body together in an overlapping region of the second welding portion, the signal line body and the connecting line body.

According to the embodiments of the present disclosure, the orthographic projection of the first welding portion on the base substrate and the orthographic projection of the second welding portion on the base substrate are located on a same side of the orthographic projection of the second connecting portion on the base substrate, and are spaced apart from each other.

According to the embodiments of the present disclosure, the display substrate further includes a second transfer structure in the third conductive layer, and the initiation signal lead is located in the first conductive layer; the initiation signal lead includes a third connecting portion and a lead body, an orthographic projection of the third connecting portion on the base substrate overlaps at least partially with an orthographic projection of the second transfer structure on the base substrate, and the third connecting portion is electrically connected to the second transfer structure in an overlapping region of the third connecting portion and the second transfer structure through at least one third via hole; the orthographic projection of the first connecting line on the base substrate overlaps at least partially with the orthographic projection of the second transfer structure on the base substrate, and the first connecting line is electrically connected to the second transfer structure in an overlapping region of the first connecting line and the second transfer structure through at least one fourth via hole; and an orthographic projection of the second welding structure on the base substrate overlaps partially with an orthographic projection of a second connecting portion on the base substrate, an orthographic projection of the lead body on the base substrate and the orthographic projection of the first connecting line on the base substrate, and the second welding structure is configured to weld the second connecting portion, the lead body and the first connecting line together in an overlapping region of the second welding structure, the second connecting portion, the lead body and the first connecting line.

According to the embodiments of the present disclosure, the first connecting line further includes a fourth connecting portion and a connecting line body, an orthographic projection of the fourth connecting portion on the base substrate overlaps at least partially with the orthographic projection of the second transfer structure on the base substrate, and the fourth connecting portion is electrically connected to the second transfer structure in an overlapping region of the fourth connecting portion and the second transfer structure; and the second welding structure includes: a third welding portion, an orthographic projection of the third welding portion on the base substrate overlaps partially with the orthographic projection of the third connecting portion on the base substrate and an orthographic projection of the fourth connecting portion on the base substrate, and the third welding portion is configured to weld the third connecting portion and the fourth connecting portion together in an overlapping region of the third welding portion, the third connecting portion and the fourth connecting portion; and/or a fourth welding portion, an orthographic projection of the fourth welding portion on the base substrate overlaps partially with the orthographic projection of the lead body on the base substrate and an orthographic projection of the connecting line body on the base substrate, and the fourth welding portion is configured to weld the lead body and the connecting line body together in an overlapping region of the fourth welding portion, the lead body and the connecting line body.

According to the embodiments of the present disclosure, the orthographic projection of the third welding portion on the base substrate and the orthographic projection of the fourth welding portion on the base substrate are located on different sides of the orthographic projection of the third connecting portion on the base substrate, and are spaced apart from each other.

According to the embodiments of the present disclosure, a material of the first welding structure and the second welding structure includes a solid welding material, the first welding structure is configured to weld the initiation signal line and the first connecting line together through at least one first welding hole, the second welding structure is configured to weld the initiation signal lead and the first connecting line together through at least one second welding hole, and a hole diameter of the at least one first welding hole and a hole diameter of the at least one second welding hole are less than or equal to a line width of the first connecting line.

According to the embodiments of the present disclosure, an orthographic projection of the at least one first welding hole on the base substrate and an orthographic projection of the at least one second welding hole on the base substrate overlap at least partially with an orthographic projection of the first connecting line on the base substrate.

According to the embodiments of the present disclosure, a material of the first welding structure and the second welding structure includes a solid welding material or a liquid welding material, the first welding structure is configured to weld the initiation signal line and the first connecting line together through a third welding hole, the second welding structure is configured to weld the initiation signal lead and the first connecting line together through a fourth welding hole, and a hole diameter of the third welding hole and a hole diameter of the fourth welding hole are greater than a line width of the first connecting line.

According to the embodiments of the present disclosure, an orthographic projection of the third welding hole on the base substrate and an orthographic projection of the fourth welding hole on the base substrate are spaced apart from an orthographic projection of the first connecting line on the base substrate.

According to the embodiments of the present disclosure, at least one of the first welding structure and the second welding structure is in contact with a surface of the first connecting line on a side away from the base substrate.

According to the embodiments of the present disclosure, the display substrate further includes: a plurality of third connecting lines and at least one fourth connecting line that are provided on the base substrate and located in the side region; the plurality of third connecting lines extend in the second direction, the at least one fourth connecting line extends in the first direction, and the plurality of third connecting lines are located on a side of the gate driving circuit away from the initiation signal lead; at least one stage of shift register unit includes a first input terminal, the first input terminals of first N stages of shift register units are electrically connected to the plurality of third connecting lines, and the first input terminals of different stages of shift register units are electrically connected to different third connecting lines; and the initiation signal line is electrically connected to the plurality of third connecting lines through the at least one fourth connecting line, where N is a positive integer.

According to the embodiments of the present disclosure, the anti-static structure in the second position includes a partition structure, and a portion of the plurality of first signal lines on a side of the partition structure close to the binding opposite region is spaced apart from a portion of the plurality of first signal lines on a side of the partition structure close to the binding region by the partition structure; the initiation signal lead is welded with the at least one fourth connecting line through a third welding structure, and the at least one fourth connecting line is welded with the plurality of third connecting lines through a fourth welding structure; and the partition structure, the third welding structure and the fourth welding structure are within a predetermined range.

According to the embodiments of the present disclosure, the display substrate further includes a sealant on the base substrate, an orthographic projection of the partition structure on the base substrate is located in the side region, and an orthographic projection of the sealant on the base substrate covers the orthographic projection of the partition structure on the base substrate.

According to the embodiments of the present disclosure, the display substrate further includes a plurality of invalid shift register units, and in the second direction, the plurality of invalid shift register units are located on a side of the gate driving circuit close to the binding opposite region; and the partition structure, the third welding structure and the fourth welding structure are located between two invalid shift register units adjacent in the second direction.

According to a second aspect of the present disclosure, a display motherboard is provided, including a first substrate region and a second substrate region, the first substrate region is configured to manufacture the display substrate described above; the first substrate region and the second substrate region have different sizes in a third direction, and the second substrate region includes a first sub-region and a second sub-region at least partially surrounding the first sub-region; the first substrate region includes a fourth conductive layer, the second substrate region includes a fifth conductive layer, and the fourth conductive layer and the fifth conductive layer are arranged in the same layer and made of the same material; and a pattern of the fourth conductive layer is the same as a pattern of a portion of the fifth conductive layer located in the first sub-region.

According to a third aspect of the present disclosure, a display panel is provided, including the display substrate described above.

According to a fourth aspect of the present disclosure, a display device is provided, including the display panel described above.

### BRIEF DESCRIPTION OF THE DRAWINGS

The above contents and other objectives, features and advantages of the present disclosure will be more apparent through the following descriptions of the embodiments of the present disclosure with reference to the accompanying drawings. In the accompanying drawings:

FIG. 1 schematically shows a plan view of a display motherboard in a comparative example;

FIG. 2 schematically shows a partial plan view of a display substrate in a comparative example;

FIG. 3 schematically shows an overall plan view of a display substrate in a comparative example;

FIG. 4 schematically shows a plan view of a display substrate according to an embodiment of the present disclosure;

FIG. 5 schematically shows a plan view of a position of an anti-static structure according to an embodiment of the present disclosure;

FIG. 6 schematically shows a plan view of a first position according to an embodiment of the present disclosure;

FIG. 7 schematically shows a first plan view of a first welding structure according to an embodiment of the present disclosure;

FIG. 8 schematically shows a first plan view of a second welding structure according to an embodiment of the present disclosure;

FIG. 9 schematically shows a plan view of a first welding hole according to an embodiment of the present disclosure;

FIG. 10 schematically shows a plan view of a second welding hole according to an embodiment of the present disclosure;

FIG. 11 schematically shows a second plan view of the first welding structure according to an embodiment of the present disclosure;

FIG. 12 schematically shows a second plan view of the second welding structure according to an embodiment of the present disclosure;

FIG. 13 schematically shows a plan view of a third welding hole according to an embodiment of the present disclosure;

FIG. 14 schematically shows a plan view of a fourth welding hole according to an embodiment of the present disclosure;

FIG. 15 schematically shows a third plan view of the first welding structure according to an embodiment of the present disclosure;

FIG. 16 schematically shows a third plan view of the second welding structure according to an embodiment of the present disclosure;

FIG. 17 schematically shows an equivalent circuit diagram of a shift register unit according to an embodiment of the present disclosure;

FIG. 18 schematically shows a first schematic diagram of a display motherboard according to an embodiment of the present disclosure;

FIG. 19 schematically shows a plan view of positions of a third welding structure and a fourth welding structure according to an embodiment of the present disclosure;

FIG. 20 schematically shows a plan view of a position of a partition structure according to an embodiment of the present disclosure;

FIG. 21 schematically shows a plan view of a sealant and a partition structure according to an embodiment of the present disclosure; and

FIG. 22 schematically shows a second plan view of the display motherboard according to an embodiment of the present disclosure.

### DETAILED DESCRIPTION OF EMBODIMENTS

In order to make objectives, technical solutions and advantages of the embodiments of the present disclosure clearer, the technical solutions of the embodiments of the present disclosure will be clearly and completely described below with reference to the accompanying drawings. Obviously, the described embodiments are merely some embodiments rather than all embodiments of the present disclosure. Based on the described embodiments of the present disclosure, all additional embodiments obtained by those ordinary skilled in the art without carrying out inventive effort fall within the scope of protection of the present disclosure.

It should be noted that in the accompanying drawings, for clarity and/or description purposes, a size and relative size of an element may be enlarged. Accordingly, the size and relative size of each element need not to be limited to those shown in the figures. In the specification and the accompanying drawings, the same or similar reference numerals represent the same or similar components.

When an element is described as being “on”, “connected to” or “coupled to” another element, the element may be directly on the another element, directly connected to the another element, or directly coupled to the another element, or an intermediate element may be provided. However, when an element is described as being “directly on”, “directly connected to” or “directly coupled to” another element, no intermediate element is provided. Other terms and/or expressions used to describe a relationship between elements, such as “between” and “directly between”, “adjacent to” and “directly adjacent to”, “on” and “directly on”, and so on, should be interpreted in a similar manner. Moreover, the term “connection” may refer to a physical connection, an electrical connection, a communicative connection, and/or a fluid connection. In addition, X-axis, Y-axis and Z-axis are not limited to three axes of a rectangular coordinate system, and may be interpreted in a broader meaning. For example, the X-axis, the Y-axis and the Z-axis may be perpendicular to each other, or may represent different directions that are not perpendicular to each other. For objectives of the present disclosure, “at least one selected from X, Y or Z” and “at least one selected from a group consisting of X, Y and Z” may be interpreted as only X, only Y, only Z, or any combination of two or more of X, Y and Z, such as XYZ, XYY, YZ and ZZ. As used herein, the term “and/or” includes any and all combinations of one or more of the listed related items.

It should be noted that although the terms “first”, “second”, and so on may be used herein to describe various components, members, elements, regions, layers and/or portions, these components, members, elements, regions, layers and/or portions should not be limited by these terms. Rather, these terms are used to distinguish one component, member, element, region, layer and/or portion from another one. Thus, for example, a first component, a first member, a first element, a first region, a first layer and/or a first portion discussed below may be referred to as a second component, a second member, a second element, a second region, a second layer and/or a second portion without departing from teachings of the present disclosure.

For ease of description, spatial relationship terms, such as “upper”, “lower”, “left”, “right”, may be used herein to describe a relationship between an element or feature and another element or feature as shown in the figures. It should be understood that the spatial relationship terms are intended to cover other different orientations of a device in use or operation in addition to the orientation described in the figures. For example, if a device in the figures is turned upside down, an element or feature described as “below” or “under” another element or feature will be oriented “above” or “on” the another element or feature.

Here, the terms “substantially”, “about”, “approximately”, “roughly” and other similar terms are used as terms of approximation rather than terms of degree, and they are intended to explain an inherent deviation of a measured or calculated value that will be recognized by those ordinary skilled in the art. Taking into account a process fluctuation, a measurement problem, an error related to a measurement of a specific quantity (that is, a limitation of a measurement system) and other factors, the terms “about” or “approximately” used herein includes a stated value and means that a specific value determined by those ordinary skilled in the art is within an acceptable range of deviation. For example, “about” may mean being within one or more standard deviations, or within ±30%, ±20%, ±10% or ±5% of the stated value.

It should be noted that the expression “the same layer” herein refers to a layer structure that is formed by firstly forming, using a same film forming process, a film layer used to form a specific pattern, and then patterning, using one-time patterning process, the film layer with a same mask. Depending on different specific patterns, the one-time patterning process may include a plurality of exposure, development or etching processes, and the specific pattern in the formed layer structure may be continuous or discontinuous. That is, a plurality of elements, components, structures and/or portions located in “the same layer” are made of the same material and formed by the same patterning process. Generally, a plurality of elements, components, structures and/or portions located in “the same layer” have substantially the same thickness.

Those skilled in the art should understand that, unless otherwise specified, the expression “height” or “thickness” herein refers to a size in a direction perpendicular to a surface of each film layer provided on the display substrate, that is, a size in a light emitting direction of the display substrate, or called a size in a normal direction of the display device.

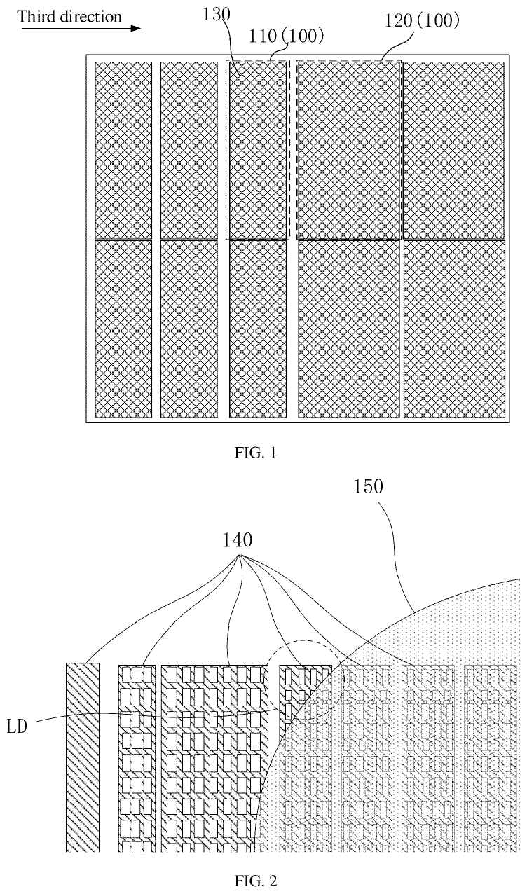

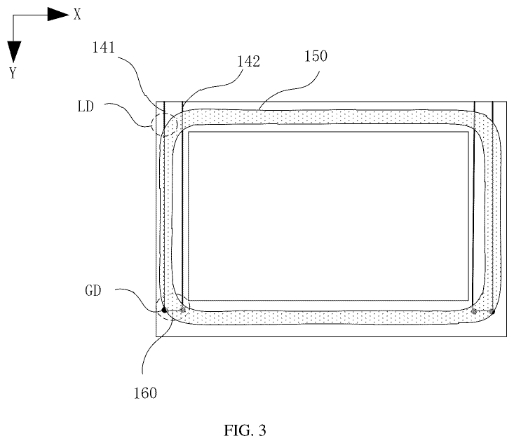

FIG. 1 schematically shows a plan view of a display motherboard in a comparative example, FIG. 2 schematically shows a partial plan view of a display substrate in a comparative example, and FIG. 3 schematically shows an overall plan view of a display substrate in a comparative example.

In a comparative example, a display motherboard is provided. Referring to FIG. 1, the display motherboard in the comparative example includes a plurality of substrate regions 100, and different substrate regions 100 are used to form display substrates having different sizes. For example, the plurality of substrate regions 100 include a first substrate region 110 and a second substrate region 120. In a third direction, a size of the first substrate region 110 is less than a size of the second substrate region 120. For example, the third direction may refer to a horizontal direction in FIG. 1. That is, a width of the first substrate region 110 is less than a width of the second substrate region 120. Accordingly, it is possible to obtain a display substrate having a first width (hereinafter referred to as a first display substrate) after cutting along the first substrate region 110, and obtain a display substrate having a second width (hereinafter referred to as a second display substrate) after cutting along the second substrate region 120. That is, it is possible to form display substrates having two widths by cutting the display motherboard, so that research and development costs of masks may be saved.

It should be noted that the above cutting step may refer to a rough cutting step performed on the display motherboard. Optionally, in addition to the rough cutting step, a fine cutting step may be further performed, for example, to cut off some non-essential devices or cut off some non-essential signal lines.

In such comparative example, a mask pattern may be multiplexed to pattern one and same film layer on the first substrate region 110 and the second substrate region 120. Exemplarily, the display motherboard includes a first film layer 130, which may include a plurality of signal lines. Patterning by multiplexing a mask pattern will be illustrated below with the first film layer 130 as an example. Firstly, a conductive material and a photoresist for manufacturing the first film layer 130 are formed in the first substrate region 110 and the second substrate region 120. Then, a mask pattern is multiplexed to expose the photoresist on the first substrate region 110 and the second substrate region 120. When exposing the second substrate region 120, it is possible to use a complete pattern of a first mask pattern for exposure. When exposing the first substrate region 110, it is possible to block a partial pattern of the first mask pattern so that a local pattern of the first mask is used to expose the first substrate region 110. After that, it is possible to form desired photolithography patterns through development on the photoresist of the first substrate region 110 and the second substrate region 120, respectively. Then, the conductive material may be etched based on the photolithography patterns on the first substrate region 110 and the second substrate region 120, so as to form desired first film layers 130 in the first substrate region 110 and the second substrate region 120.

With such exposure method, the first film layer 130 formed on the second substrate region 120 is a complete pattern, while the first film layer 130 formed on the first substrate region 110 is an incomplete pattern. Therefore, the first film layer 130 needs to be further processed. Exemplarily, it is possible to cut or remove excess signal lines in the first film layer 130, and it is also possible to lap some signal lines, so that the signal lines on the finally obtained display substrate may transmit electrical signals as required.

However, the display substrate obtained by the above method may have some missing components. For example, anti-static units may be formed on an upper left corner, an upper right corner (two corners of the second display substrate on a side close to the binding opposite region), a lower left corner, and a lower right corner (two corners of the second display substrate on a side close to the binding region) of the second display substrate. The anti-static units may timely release static electricity on the signal lines connected thereto to a ground line, thereby preventing excessive electrostatic accumulation on the signal lines. However, on the first display substrate, the anti-static units on an upper left corner and an upper right corner (two corners of the first display substrate on a side close to the binding opposite region) may be cut off, resulting in a lack of anti-static protection on the upper left and upper right corners of the first display substrate. It should be noted that the left, right, upper and lower sides may refer to left, right, upper and lower sides of the display substrate (screen) viewed by human eyes during display.

Moreover, in the first display substrate formed by the above method, some signal lines on the upper left and upper right have a risk of being exposed due to an incomplete coverage of an encapsulation layer 150, and the exposed signal lines are prone to introducing static electricity. For example, referring to FIG. 2, a plurality of signal lines 140 are provided at the upper left corner of the display substrate, where four signal lines 140 on the left side are exposed without being effectively covered by the encapsulation layer 150.

Referring to FIG. 3, the four exposed signal lines 140 include an initiation signal line 141 used to provide an initiation signal to a gate driving circuit, and the initiation signal line 141 is electrically connected to the gate driving circuit through an initiation signal lead 142. The initiation signal line 141 and the initiation signal lead 142 both extend in a second direction Y and are electrically connected at a lower left corner and a lower right corner of the first display substrate through a connecting line 160 extending in a first direction X. The first direction X intersects with the second direction Y. For example, the initiation signal line 141 and the initiation signal lead 142 are located in the same layer and made of the same material, the connecting line 160 is located in a different layer from the initiation signal line 141, and the three are electrically connected through corresponding connection holes. As mentioned above, the initiation signal line 141 has a risk of being exposed due to an incomplete coverage of the encapsulation layer (such position is hereinafter referred to as an exposure risk position LD). The initiation signal line 141 extends from an upper end to a lower end of the display substrate, so that the initiation signal line 141 is relatively long. Moreover, a turning point GD is formed at a connection between the initiation signal line 141 and the initiation signal lead 142. Therefore, once the exposed initiation signal line 141 introduces static electricity, the introduced static electricity is prone to accumulate in large quantities at the connection (i.e., the turning point GD) between the initiation signal line 141 and the initiation signal lead 142, which may easily lead to electrostatic discharge at the turning point GD and then cause nearby signal lines, transfer structures or related elements to be broken down by the static electricity.

In view of this, the embodiments of the present disclosure provide a display substrate, a display motherboard used to manufacture the display substrate may include a plurality of substrate regions, and different substrate regions are used to manufacture display substrates having different sizes.

The display substrate in the embodiments of the present disclosure includes a display region, a binding region, a binding opposite region, a side region, a first corner region, and a second corner region. The side region and the display region are arranged in a first direction, and the binding opposite region, the display region and the binding region are arranged in sequence in a second direction. The first direction intersects with the second direction. The first corner region is located between the side region and the binding opposite region and at least partially surrounds a first corner of the display region. The second corner region is located between the side region and the binding region and at least partially surrounds a second corner of the display region.

The display substrate in the embodiments of the present disclosure further includes a base substrate, a gate driving circuit provided on the base substrate and located in the side region, and a plurality of first signal lines provided on the base substrate and located in the side region, the first corner region and the second corner region. The gate driving circuit includes multi-stage shift register units connected in cascade.

The plurality of first signal lines are located on a side of the gate driving circuit away from the display region. The plurality of first signal lines include an initiation signal line and an initiation signal lead. The initiation signal lead is located on a side of the initiation signal line close to the gate driving circuit. The initiation signal line and the initiation signal lead both extend in the second direction and are electrically connected through a first connecting line in the second corner region. The plurality of first signal lines are provided with an anti-static structure which is located in at least one of a first position and a second position. The first position includes a connection between the initiation signal line and the first connecting line and a connection between the initiation signal lead and the first connecting line. The second position includes a portion of the plurality of first signal lines on a side of a row where a first-stage shift register unit is located close to the binding opposite region.

For the display substrates having different sizes manufactured by multiplexing the mask pattern, even if some display substrates with a particular size lack some anti-static units, the electrostatic accumulation at the connection between the initiation signal line (and/or the initiation signal lead) and the first connecting line may be improved through the above-mentioned anti-static structure, so that the risk of electrostatic breakdown at the connection between the initiation signal line (and/or the initiation signal lead) and the first connecting line may be reduced, and a product yield of the display substrate using the manufacturing method may be increased.

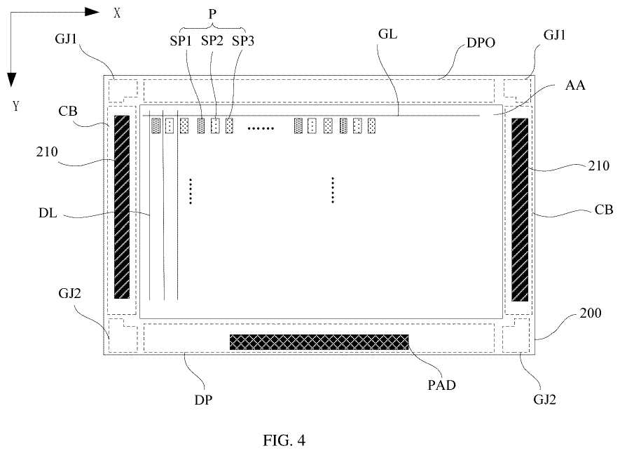

The display substrate in the embodiments of the present disclosure will be described in detail below with reference to FIG. 4 to FIG. 22.

FIG. 4 schematically shows a plan view of a display substrate according to an embodiment of the present disclosure.

Referring to FIG. 4, the display substrate in the embodiments of the present disclosure includes a display region AA, a binding region DP, a binding opposite region DPO, a side region CB, a first corner region GJ1, and a second corner region GJ2. The side region CB and the display region AA are arranged in the first direction X, and the binding opposite region DPO, the display region AA and the binding region DP are arranged in sequence in the second direction Y. The first direction X intersects with the second direction Y. The first corner region GJ1 is located between the side region CB and the binding opposite region DPO and at least partially surrounds the first corner of the display region AA. The second corner region GJ2 is located between the side region CB and the binding region DP and at least partially surrounds the second corner of the display region AA. For example, the second direction Y may be a vertical direction in FIG. 4, and the first direction X may be a horizontal direction in FIG. 4, that is, the second direction Y and the first direction X are perpendicular to each other.

In the embodiments of the present disclosure, the display region AA may have various shapes. For example, the display region AA may be provided in various shapes such as a closed polygon including straight sides (e.g., a rectangle), a circle or an ellipse, etc. including a curved side, and a semicircle or a semi-ellipse, etc. including a straight side and a curved side. In the embodiments of the present disclosure, the display region AA is provided as a region having a quadrangular shape including straight sides. It should be understood that this is merely an exemplary embodiment of the present disclosure rather than a limitation to the present disclosure.

The binding region DP and the binding opposite region DPO may be arranged on two opposite sides of the display region AA. For example, the binding region DP and the binding opposite region DPO may be arranged on upper and lower sides of the display region AA, so that the binding opposite region DPO, the display region AA and the binding region DP are arranged in sequence in the second direction Y.

The display substrate may include two side regions CB arranged on two opposite sides of the display region AA and are located on different sides of the display region AA from the binding region DP and the binding opposite region DPO. For example, the two side regions CB are located on left and right sides of the display region AA, so that the side regions CB and the display region AA are arranged in the first direction X.

The display region AA may be a rectangle, which has four corners. The first corner may refer to a corner of the display region AA on a side close to the binding opposite region DPO, and the second corner may refer to a corner of the display region AA close to the binding region DP. Referring to FIG. 4, the first corner may refer to an upper left corner or an upper right corner of the display region AA, and the second corner may refer to a lower left corner or a lower right corner of the display region AA. The first corner region GJ1 may surround an outer periphery of the first corner, and the second corner region GJ2 may surround an outer periphery of the second corner. The display substrate may further include a plurality of signal lines (such as a first signal line to be mentioned below) in at least the side region CB and a binding pad PAD in the binding region DP. The plurality of signal lines may extend from the side region CB to the second corner region GJ2, and then extend to the binding region DP through the second corner region GJ2 to electrically connect with the binding pad PAD in the binding region DP.

The display substrate may further include a base substrate 200 and a plurality of pixel units P provided on the base substrate 200 and located in the display region AA. The plurality of pixel units P may be arranged in an array in the second direction Y and the first direction X. Each pixel unit P may include a plurality of sub-pixels PX. For example, the pixel unit P may include a first sub-pixel SP1, a second sub-pixel SP2 and a third sub-pixel SP3. Exemplarily, the first sub-pixel SP1, the second sub-pixel SP2 and the third sub-pixel SP3 may be provided as a red sub-pixel, a green sub-pixel and a blue sub-pixel, but the embodiments of the present disclosure are not limited to this.

The display substrate further includes a plurality of gate lines GL and a plurality of data lines DL that are provided on the base substrate 200 and located in at least the display region AA. The gate line GL extends in the first direction X, and the data line DL extends in the second direction Y. Exemplarily, a sub-pixel PX is connected to a data line DL and a gate line GL, sub-pixels PX in one and same row are connected to one and same gate line GL, sub-pixels PX in different rows are connected to different gate lines GL, sub-pixels PX in one and same column are connected to one and same data line DL, and sub-pixels PX in different columns are connected to different data lines DL.

The display substrate in the embodiments of the present disclosure further includes a gate driving circuit 210 provided on the base substrate 200 and located in the side region CB, and the gate driving circuit 210 includes multi-stage shift register units connected in cascade.

In the embodiments shown in FIG. 4, the gate driving circuit 210 is located on a left side and a right side of the display region AA, respectively. It should be noted that the left side and the right side may refer to a left side and a right side of the display substrate (screen) viewed by human eyes during display. The display substrate further includes a driver chip (not shown), which may be located in the binding region DP.

The driver chip includes a data driving circuit used to regularly latch input data in sequence according to a first clock signal, convert the latched data into an analog signal and then input the analog signal to each data line DL of the display substrate. The gate driving circuit 210 is generally implemented by a shift register unit, which converts a second clock signal into an on/off voltage and outputs the on/off voltage to each gate line GL of the display substrate respectively.

It should be noted that FIG. 4 shows that the gate driving circuit 210 is located on the left side and the right side of the display region AA. However, the embodiments of the present disclosure are not limited thereto. The gate driving circuit 210 may be located at any suitable position on the display substrate.

Optionally, each stage of shift register units is connected to a gate line GL, and scanning signals are sequentially output through stages of shift register units to achieve progressive scanning of pixel units. In some embodiments, each stage of shift register units may also be connected to a plurality of gate lines GL. In this way, it may adapt to a development trend of high resolution and narrow bezel of display substrates.

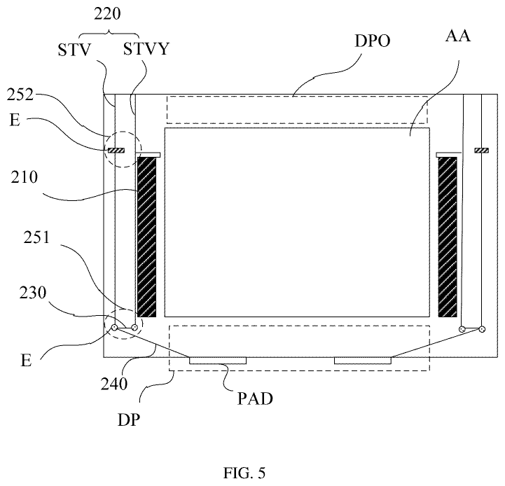

FIG. 5 schematically shows a plan view of a position of an anti-static structure according to an embodiment of the present disclosure.

Referring to FIG. 4 and FIG. 5, the display substrate in the embodiments of the present disclosure further includes a plurality of first signal lines 220 provided on the base substrate 200 and located in the side region CB, the first corner region GJ1 and the second corner region GJ2. The plurality of first signal lines 220 are located on a side of the gate driving circuit 210 away from the display region AA. The plurality of first signal lines 220 include an initiation signal line STV and an initiation signal lead STVY. The initiation signal lead STVY is located on a side of the initiation signal line STV close to the gate driving circuit 210. The initiation signal line STV and the initiation signal lead STVY both extend in the second direction Y and are electrically connected through a first connecting line 230 in the second corner region GJ2.

In the embodiments of the present disclosure, the initiation signal line STV and the initiation signal lead STVY both extend in the second direction Y from the first corner region GJ1 to the second corner region GJ2 through the side region CB. The initiation signal line STV and the initiation signal lead STVY are located in the same layer and made of the same material, and the first connecting line 230 is located in a different film layer from the initiation signal line STV and the initiation signal lead STVY. For example, the first connecting line 230 is located in a second conductive layer, and the initiation signal line STV and the initiation signal lead STVY are located in a first conductive layer. The first connecting line 230 overlaps at least partially with the initiation signal line STV, and the first connecting line and the initiation signal line are electrically connected through a connection hole at an overlapping portion of the two. The first connecting line 230 further overlaps at least partially with the initiation signal lead STVY, and the first connecting line and the initiation signal lead are electrically connected through a connection hole at an overlapping portion of the two.

The initiation signal line STV is located on an outer side of the initiation signal lead STVY. The initiation signal line STV is electrically connected to the binding pad PAD in the binding region DP through a transfer line 240, and then electrically connected to the driver chip through the binding pad PAD. The initiation signal lead STVY is electrically connected to the gate driving circuit 210, specifically to first N stages of shift register units in the gate driving circuit 210, so as to provide an initiation signal for the first N stages of shift register units.

Referring to FIG. 5, in the embodiments of the present disclosure, the plurality of first signal lines 220 are provided with an anti-static structure E, which is located in at least one of a first position 251 and a second position 252. The first position includes a connection between the initiation signal line STV and the first connecting line 230 and a connection between the initiation signal lead STVY and the first connecting line 230, such as a position near a connection hole for the first connecting line 230 and at least one of the initiation signal line STV and the initiation signal lead STVY. The second position includes a position at a portion of the plurality of first signal lines 220 on a side of a row where the first-stage shift register unit is located close to the binding opposite region DPO, such as a position on the initiation signal line STV and the initiation signal lead STVY above the row where the first-stage shift register unit is located.

In the embodiments of the present disclosure, if the anti-static structure E is provided in the first position 251, which is a position where static electricity is prone to accumulate on the initiation signal line STV and the initiation signal lead STVY, the electrostatic accumulation may be improved directly. For example, the anti-static structure E may include a structure that may reduce a connection impedance at the connection. For example, at a position near the connection hole for the initiation signal line STV (and/or the initiation signal lead STVY) and the first connecting line 230, the initiation signal line STV (and/or the initiation signal lead STVY) and the first connecting line 230 may be welded by an additional conductive material, so that a contact area between the initiation signal line STV (and/or the initiation signal lead STVY) and the first connecting line 230 may be increased, a connection impedance between the initiation signal line STV (and/or the initiation signal lead STVY) and the first connecting line 230 may be reduced, and then the electrostatic accumulation at the connection between the initiation signal line STV (and/or the initiation signal lead STVY) and the first connecting line 230 may be improved directly.

If the anti-static structure E is provided in the second position 252, which is a region near the exposure risk position on the initiation signal line STV and the initiation signal lead STVY, it is possible to reduce the static electricity introduced from the outside on the initiation signal line STV and the initiation signal lead STVY. For example, it is possible to cut off the initiation signal line STV (and/or the initiation signal lead STVY) at the second position 252, then the portion of the initiation signal line STV (and/or the initiation signal lead STVY) at the exposure risk position is insulated and spaced apart from other portions, so that an electrostatic transmission path may be blocked, and then the electrostatic accumulation at the connection between the initiation signal line STV (and/or the initiation signal lead STVY) and the first connecting line 230 may be improved indirectly.

In the embodiments of the present disclosure, the anti-static structure E may be located in the first position 251 to reduce the connection impedance between the initiation signal line STV (and/or the initiation signal lead STVY) and the first connecting line 230; or the anti-static structure E may be located in the second position 252 to reduce static electricity introduced by the initiation signal line STV (and/or the initiation signal lead STVY) from the outside; or the anti-static structure E may be located in both the first position 251 and the second position 252, which may reduce the static electricity introduced by the initiation signal line STV (and/or the initiation signal lead STVY) from the outside and further reduce the connection impedance between the initiation signal line STV (and/or the initiation signal lead STVY) and the first connecting line 230, thereby achieving a better electrostatic protection.

In this way, for the display substrates having different sizes manufactured by multiplexing the mask pattern, even if display substrates having a particular size lack some anti-static units, the electrostatic accumulation at the connection between the initiation signal line STV (and/or the initiation signal lead STVY) and the first connecting line 230 may be improved through the above-mentioned anti-static structure, so that the risk of electrostatic breakdown at the connection between the initiation signal line STV (and/or the initiation signal lead STVY) and the first connecting line 230 may be reduced, and a product yield of the display substrate using the manufacturing method may be increased.

The display substrate of the embodiments of the present disclosure will be described in detail below.

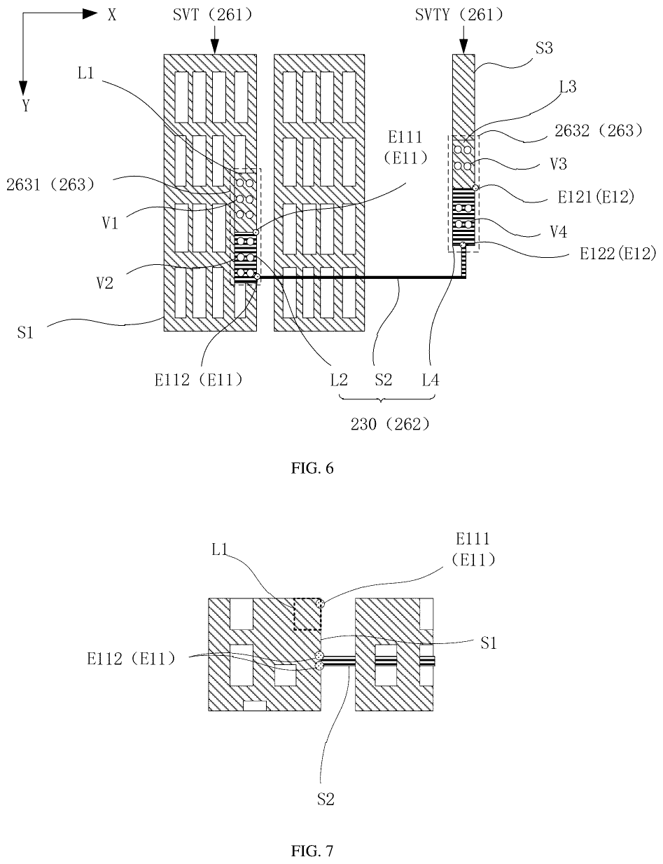

FIG. 6 schematically shows a plan view of the first position according to an embodiment of the present disclosure.

Referring to FIG. 4 to FIG. 6, in some specific embodiments, the anti-static structure E in the first position 251 includes a first welding structure E11 and/or a second welding structure E12. In other words, the anti-static structure E in the first position 251 may include only the first welding structure E11; or the anti-static structure E in the first position 251 may include only the second welding structure E12; or the anti-static structure E in the first position 251 may include both the first welding structure E11 and the second welding structure E12. For the sake of clarity, unless otherwise specified, the display substrate of the embodiments of the present disclosure will be described below taking the anti-static structure E in the first position 251 including both the first welding structure E11 and the second welding structure E12 as an example.

At the connection between the initiation signal line STV and the first connecting line 230, the initiation signal line STV and the first connecting line 230 are welded together by the first welding structure E11, so that the connection impedance between the initiation signal line STV and the first connecting line 230 may be reduced. At the connection between the initiation signal lead STVY and the first connecting line 230, the initiation signal lead STVY and the first connecting line 230 are welded together by the second welding structure E12, so that the connection impedance between the initiation signal lead STVY and the first connecting line 230 may be reduced.

In the embodiments of the present disclosure, a via hole may be formed at the connection between the initiation signal line STV and the first connecting line 230 using a laser beam, and then a welding material may be filled into the via hole and heated to form the first welding structure E11. The welding material has conductivity, so that the filled welding material may conduct the initiation signal line STV and the first connecting line 230. By using the first welding structure E11, it is possible to additionally increase a conductive area between the initiation signal line STV and the first connecting line 230 on the basis of an existing conductive structure of the initiation signal line STV and the first connecting line 230, so that the connection impedance between the initiation signal line STV and the first connecting line 230 may be reduced.

Accordingly, a via hole may be formed at the connection between the initiation signal lead STVY and the first connecting line 230 using a laser beam, and then a welding material may be filled into the via hole and heated to form the second welding structure E12. The welding material has conductivity, so that the filled welding material may conduct the initiation signal lead STVY and the first connecting line 230. By using the first welding structure E11, it is possible to additionally increase a conductive area between the initiation signal lead STVY and the first connecting line 230 on the basis of an existing conductive structure of the initiation signal lead STVY and the first connecting line 230, so that the connection impedance between the initiation signal lead STVY and the first connecting line 230 may be reduced.

Optionally, at least one of the first welding structure E11 and the second welding structure E12 may select a welding material with good conductivity, so that the connection impedance between the initiation signal line STV and the first connecting line 230 may be significantly reduced. For example, the welding material may include tungsten and silver, etc.

Optionally, a material of the first welding structure E11 and a material of the second welding structure E12 may be the same, and the first welding structure E11 and the second welding structure E12 may be formed synchronously, so that the manufacturing process may be simplified.

In some specific embodiments, the display substrate includes a first conductive layer 261, a second conductive layer 262 on a side of the first conductive layer 261 away from the base substrate 200, and a third conductive layer 263 on a side of the second conductive layer 262 away from the second conductive layer 262.

In the embodiments of the present disclosure, the first conductive layer 261 may include a gate metal layer, and the second conductive layer 262 may include a source/drain electrode layer. The display substrate further includes a plurality of transistors, and each of the transistors includes a first electrode, a second electrode and a gate electrode, where one of the first electrode and the second electrode is a source electrode, and the other is a drain electrode. The gate electrodes of at least some of the transistors are located in the gate metal layer, and the first electrodes and second electrodes of at least some of the transistors are located in the source/drain electrode layer. The third conductive layer 263 may be an arbitrary conductive film layer on a side of the source/drain electrode layer away from the base substrate 200, which may be determined according to actual needs and not limited in the embodiments of the present disclosure. For example, the display substrate in the embodiments of the present disclosure may be applied to a liquid crystal display panel, and the third conductive layer 263 may include a pixel electrode layer for providing a pixel electrode or a common electrode layer for providing a common electrode, etc.

The display substrate further includes a first transfer structure 2631 in the third conductive layer 263. The initiation signal line STV is located in the first conductive layer 261, and the first connecting line 230 is located in the second conductive layer 262. The initiation signal line STV includes a first connecting portion L1 and a signal line body S1. It should be noted that a portion of the signal line body S1 is covered by the first connecting line 230 (specifically a second connecting portion L2 mentioned below) and thus not shown in FIG. 6. An orthographic projection of the first connecting portion L1 on the base substrate 200 overlaps at least partially with an orthographic projection of the first transfer structure 2631 on the base substrate 200, and the first connecting portion L1 is electrically connected to the first transfer structure 2631 in an overlapping region of the first connecting portion and the first transfer structure through at least one first via hole V1. An orthographic projection of the first connecting line 230 on the base substrate 200 overlaps at least partially with the orthographic projection of the first transfer structure 2631 on the base substrate 200, and the first connecting line 230 is electrically connected to the first transfer structure 2631 in an overlapping region of the first connecting line and the first transfer structure through at least one second via hole V2. An orthographic projection of the first welding structure E11 on the base substrate 200 overlaps partially with the orthographic projection of the first connecting portion L1 on the base substrate 200, an orthographic projection of the signal line body S1 on the base substrate 200 and the orthographic projection of the first connecting line 230 on the base substrate 200, and the first welding structure E11 may weld the first connecting portion L1, the signal line body S1 and the first connecting line 230 together in an overlapping region of the first welding structure, the first connecting portion, the signal line body and the first connecting line.

In the embodiments of the present disclosure, insulation layers are provided between the first conductive layer 261 and the third conductive layer 263 and between the first conductive layer 261 and the second conductive layer 262. The first via hole V1 penetrates the insulation layer between the first conductive layer 261 and the third conductive layer 263 and exposes the first connecting portion L1. The first via hole V1 is filled with a conductive material which has one end connected to the first transfer structure 2631 and the other end connected to the first connecting portion L1, so that the first transfer structure 2631 may be electrically connected to the first connecting portion L1 through the conductive material in the first via hole V1. Optionally, the conductive material in the first via hole V1 and the first transfer structure 2631 are formed into an integrated structure. The second via hole V2 penetrates an insulation layer between the second conductive layer 262 and the third conductive layer 263 and exposes the first connecting line 230. The second via hole V2 is filled with a conductive material which has one end connected to the first transfer structure 2631 and the other end connected to the first connecting line 230, so that the first transfer structure 2631 may be electrically connected to the first connecting line 230 through the conductive material in the second via hole V2. Optionally, the conductive material in the second via hole V2 and the first transfer structure 2631 are formed into an integrated structure.

Optionally, the first connecting portion L1 is electrically connected to the first transfer structure 2631 through a plurality of first via holes V1, and the plurality of first via holes V1 are arranged in an array in the first direction X and the second direction Y. For example, referring to FIG. 6, the first connecting portion L1 is electrically connected to the first transfer structure 2631 through six first via holes V1, and the six first via holes V1 are arranged in three rows and two columns in the first direction X and the second direction Y. The first connecting line 230 is electrically connected to the first transfer structure 2631 through a plurality of second via holes V2, and the plurality of second via holes V2 are arranged in an array in the first direction X and the second direction Y. For example, referring to FIG. 6, the first connecting line 230 is electrically connected to the first transfer structure 2631 through six second via holes V2, and the six second via holes V2 are arranged in three rows and two columns in the first direction X and the second direction Y.

Optionally, the orthographic projection of the first welding structure E11 on the base substrate 200 overlaps with an edge of the orthographic projection of the first connecting portion L1 on the base substrate 200, and the orthographic projection of the first welding structure E11 on the base substrate 200 is spaced apart from an orthographic projection of the first via hole V1 on the base substrate 200 and an orthographic projection of the second via hole V2 on the base substrate 200, so that a sufficient welding space is reserved for the first welding structure E11, and an impact of the first welding structure E11 on existing structures may be reduced.

In some specific embodiments, the first connecting line 230 includes a second connecting portion L2 and a connecting line body S2. An orthographic projection of the second connecting portion L2 on the base substrate 200 overlaps at least partially with the orthographic projection of the first transfer structure 2631 on the base substrate 200, and the second connecting portion L2 is electrically connected to the first transfer structure 2631 in an overlapping region of the second connecting portion and the first transfer structure through the second via hole V2.

Optionally, the orthographic projection of the second connecting portion L2 on the base substrate 200 overlaps at least partially with the orthographic projection of the signal line body S1 on the base substrate 200. The orthographic projection of the second connecting portion L2 on the base substrate 200 and the orthographic projection of the first connecting portion L1 on the base substrate 200 may be arranged in the second direction Y, an orthographic projection of the plurality of first via holes V1 on the base substrate 200 falls within the orthographic projection of the first connecting portion L1 on the base substrate 200, and an orthographic projection of the plurality of second via holes V2 on the base substrate 200 falls within the orthographic projection of the second connecting portion L2 on the base substrate 200.

Optionally, the plurality of first via holes V1 and the plurality of second via holes V2 are arranged in an array in the first direction X and the second direction Y. For example, referring to FIG. 6, the six first via holes V1 and the six second via holes V2 are arranged in six rows and two columns in the first direction X and the second direction Y.

The first welding structure E11 includes a first welding portion E111 and/or a second welding portion E112. An orthographic projection of the first welding portion E111 on the base substrate 200 overlaps partially with the orthographic projection of the first connecting portion L1 on the base substrate 200 and the orthographic projection of the second connecting portion L2 on the base substrate 200, and the first welding portion E111 may weld the first connecting portion L1 and the second connecting portion L2 together in an overlapping region of the first welding portion, the first connecting portion and the second connecting portion. An orthographic projection of the second welding portion E112 on the base substrate 200 overlaps partially with the orthographic projection of the signal line body SI on the base substrate 200 and an orthographic projection of the connecting line body S2 on the base substrate 200, and the second welding portion E112 may weld the signal line body S1 and the connecting line body S2 together in an overlapping region of the second welding portion, the signal line body and the connecting line body.

In the embodiments of the present disclosure, the first welding structure E11 may include only the first welding portion E111, or the first welding structure E11 may include only the second welding portion E112, or the first welding structure E11 may include both the first welding portion E111 and the second welding portion E112. For clarity of expression, unless otherwise specified, the embodiments of the present disclosure will be described below taking the first welding structure E11 including both the first welding portion E111 and the second welding portion E112 as an example.

In the embodiments of the present disclosure, the orthographic projection of the first welding portion E11 on the base substrate 200 and the orthographic projection of the second welding portion E112 on the base substrate 200 may be located on the same side or different sides of the orthographic projection of the second connecting portion L2 on the base substrate 200. Exemplarily, the second connecting portion L2 may be a rectangle, and the orthographic projection of the first welding portion E111 on the base substrate 200 and the orthographic projection of the second welding portion E112 on the base substrate 200 may be located on two opposite sides of the orthographic projection of the second connecting portion L2 on the base substrate 200. For example, in the first direction X, one of the orthographic projection of the first welding portion E111 on the base substrate 200 and the orthographic projection of the second welding portion E112 on the base substrate 200 is located on a side of the orthographic projection of the second connecting portion L2 on the base substrate 200 away from the display region AA, and the other is located on a side of the orthographic projection of the second connecting portion L2 on the base substrate 200 close to the display region AA. Alternatively, the orthographic projection of the first welding portion E111 on the base substrate 200 and the orthographic projection of the second welding portion E112 on the base substrate 200 may be located on two adjacent sides of the orthographic projection of the second connecting portion L2 on the base substrate 200. For example, one of the orthographic projection of the first welding portion E111 on the base substrate 200 and the orthographic projection of the second welding portion E112 on the base substrate 200 is located on a side of the orthographic projection of the second connecting portion L2 on the base substrate 200 close to the binding opposite region DPO, and the other is located on a side of the orthographic projection of the second connecting portion L2 on the base substrate 200 close to the display region AA, which may be specifically determined according to actual needs and will not be listed one by one in the embodiments of the present disclosure.

In some specific embodiments, the orthographic projection of the first welding portion E111 on the base substrate 200 and the orthographic projection of the second welding portion E112 on the base substrate 200 are located on the same side of the orthographic projection of the second connecting portion L2 on the base substrate 200, and the orthographic projection of the first welding portion E111 on the base substrate 200 is spaced apart from the orthographic projection of the second welding portion E112 on the base substrate 200.

For example, in the first direction X, the connecting line body S2 is connected to a side of the second connecting portion L2 close to the display region AA, and the orthographic projection of the first welding portion E111 on the base substrate 200 and the orthographic projection of the second welding portion E112 on the base substrate 200 are both located on a side of the orthographic projection of the second connecting portion L2 on the base substrate 200 close to the display region AA. Referring to FIG. 6, the first welding portion E111 and the second welding portion E112 are both located on the right side of the second connecting portion L2, where the first welding portion E111 is located at an upper right corner of the second connecting portion L2, and the second welding portion E112 is located directly below the first welding portion E111.

In this way, on one hand, an effective welding of the first welding portion E111 and the second welding portion E112 may be ensured, and on the other hand, a sufficient distance between the first welding portion E111, the second welding portion E112 and other signal lines may be kept, so as to prevent the first welding portion E111 and the second welding portion E112 from being short-circuited with other signal lines.

Optionally, the second connecting portion L2 may be a rectangle, and the orthographic projection of the first welding portion E111 on the base substrate overlaps with a rectangle corner of the orthographic projection of the second connecting portion L2 on the base substrate 200.

In some specific embodiments, the display substrate further includes a second transfer structure 2632 in the third conductive layer 263, and the initiation signal lead STVY is located in the first conductive layer 261.

The initiation signal lead STVY includes a third connecting portion L3 and a lead body S3. It should be noted that a portion of the lead body S3 is covered by the first connecting line 230 (specifically a fourth connecting portion L4 mentioned below) and thus not shown in FIG. 6. An orthographic projection of the third connecting portion L3 on the base substrate 200 overlaps at least partially with an orthographic projection of the second transfer structure 2632 on the base substrate 200, and the third connecting portion L3 is electrically connected to the second transfer structure 2632 in an overlapping region of the third connecting portion and the second transfer structure through at least one third via hole V3. The orthographic projection of the first connecting line 230 on the base substrate 200 overlaps at least partially with the orthographic projection of the second transfer structure 2632 on the base substrate 200, and the first connecting line 230 is electrically connected to the second transfer structure 2632 in an overlapping region of the first connecting line and the second transfer structure through at least one fourth via hole V4. The orthographic projection of the second welding structure E12 on the base substrate 200 overlaps partially with the orthographic projection of the second connecting portion L2 on the base substrate 200, an orthographic projection of the lead body S3 on the base substrate 200 and the orthographic projection of the first connecting line 230 on the base substrate 200, and the second welding structure E12 may weld the second connecting portion L2, the lead body S3 and the first connecting line 230 together in an overlapping region of the second welding structure, the second connecting portion, the lead body and the first connecting line.

In the embodiments of the present disclosure, the third via hole V3 penetrates the insulation layer between the first conductive layer 261 and the third conductive layer 263 and exposes the third connecting portion L3. The third via hole V3 is filled with a conductive material which has one end connected to the second transfer structure 2632 and the other end connected to the third connecting portion L3, so that the second transfer structure 2632 may be electrically connected to the third connecting portion L3 through the conductive material in the third via hole V3. Optionally, the conductive material in the third via hole V3 and the second transfer structure 2632 are formed into an integrated structure. The fourth via hole V4 penetrates the insulation layer between the second conductive layer 262 and the third conductive layer 263 and exposes the first connecting line 230. The fourth via hole V4 is filled with a conductive material which has one end connected to the second transfer structure 2632 and the other end connected to the first connecting line 230, so that the second transfer structure 2632 may be electrically connected to the first connecting line 230 through the conductive material in the fourth via hole V4. Optionally, the conductive material in the fourth via hole V4 and the second transfer structure 2632 are formed into an integrated structure.

Optionally, the third connecting portion L3 is electrically connected to the second transfer structure 2632 through a plurality of third via holes V3, and the plurality of third via holes V3 are arranged in an array in the first direction X and the second direction Y. For example, referring to FIG. 6, the third connecting portion L3 is electrically connected to the second transfer structure 2632 through four third via holes V3, and the four third via holes V3 are arranged in two rows and two columns in the first direction X and the second direction Y. The first connecting line 230 is electrically connected to the second transfer structure 2632 through a plurality of fourth via holes V4, and the plurality of fourth via holes V4 are arranged in an array in the first direction X and the second direction Y. For example, referring to FIG. 6, the first connecting line 230 is electrically connected to the second transfer structure 2632 through four fourth via holes V4, and the four fourth via holes V4 are arranged in two rows and two columns in the first direction X and the second direction Y.

Optionally, the orthographic projection of the second welding structure E12 on the base substrate 200 overlaps with an edge of the orthographic projection of the third connecting portion L3 on the base substrate 200, and the orthographic projection of the second welding structure E12 on the base substrate 200 is spaced apart from the orthographic projection of the first via hole V1 on the base substrate 200 and the orthographic projection of the second via hole V2 on the base substrate 200, so that a sufficient welding space is reserved for the second welding structure E12, and an impact of the second welding structure E12 on existing structures may be reduced.

In some specific embodiments, the first connecting line 230 further includes a fourth connecting portion L4 and a connecting line body S2. An orthographic projection of the fourth connecting portion L4 on the base substrate 200 overlaps at least partially with the orthographic projection of the second transfer structure 2632 on the base substrate 200, and the fourth connecting portion L4 is electrically connected to the second transfer structure 2632 in an overlapping region of the fourth connecting portion and the second transfer structure.

Optionally, the orthographic projection of the fourth connecting portion L4 on the base substrate 200 overlaps at least partially with the orthographic projection of the lead body S3 on the base substrate 200. The orthographic projection of the third connecting portion L3 on the base substrate 200 and the orthographic projection of the fourth connecting portion L4 on the base substrate 200 may be arranged in the second direction Y, an orthographic projection of the plurality of third via holes V3 on the base substrate 200 falls within the orthographic projection of the third connecting portion L3 on the base substrate 200, and an orthographic projection of the plurality of fourth via holes V4 on the base substrate 200 falls within the orthographic projection of the fourth connecting portion L4 on the base substrate 200.

Optionally, the plurality of third via holes V3 and the plurality of fourth via holes V4 are arranged in an array in the first direction X and the second direction Y. For example, referring to FIG. 6, the four third via holes V3 and the four fourth via holes V4 are arranged in four rows and two columns in the first direction X and the second direction Y.

The second welding structure E12 includes a third welding portion E121 and/or a fourth welding portion E122. An orthographic projection of the third welding portion E121 on the base substrate 200 overlaps partially with the orthographic projection of the third connecting portion L3 on the base substrate 200 and the orthographic projection of the fourth connecting portion L4 on the base substrate 200, and the third welding portion E121 may weld the third connecting portion L3 and the fourth connecting portion L4 together in an overlapping region of the third welding portion, the third connecting portion and the further connecting portion. An orthographic projection of the fourth welding portion E122 on the base substrate 200 overlaps partially with the orthographic projection of the lead body S3 on the base substrate 200 and the orthographic projection of the connecting line body S2 on the base substrate 200, and the fourth welding portion E122 may weld the lead body S3 and the connecting line body S2 together in an overlapping region of the fourth welding portion, the lead body and the connecting line body.

In the embodiments of the present disclosure, the second welding structure E12 may include only the third welding portion E121, or the second welding structure E12 may include only the fourth welding portion E122, or the second welding structure E12 may include both the third welding portion E121 and the fourth welding portion E122. For clarity of expression, unless otherwise specified, the embodiments of the present disclosure will be described below taking the second welding structure E12 including both the third welding portion E121 and the fourth welding portion E122 as an example.

In the embodiments of the present disclosure, the orthographic projection of the third welding portion E121 on the base substrate 200 and the orthographic projection of the fourth welding portion E122 on the base substrate 200 may be located on the same side or different sides of the orthographic projection of the fourth connecting portion L4 on the base substrate 200. Exemplarily, the fourth connecting portion L4 may be a rectangle, and the orthographic projection of the third welding portion E121 on the base substrate 200 and the orthographic projection of the fourth welding portion E122 on the base substrate 200 may be located on two opposite sides of the orthographic projection of the fourth connecting portion L4 on the base substrate 200. For example, in the first direction X, one of the orthographic projection of the third welding portion E121 on the base substrate 200 and the orthographic projection of the fourth welding portion E122 on the base substrate 200 is located on a side of the orthographic projection of the fourth connecting portion L4 on the base substrate 200 away from the binding opposite region DPO, and the other is located on a side of the orthographic projection of the fourth connecting portion L4 on the base substrate 200 close to the binding opposite region DPO. Alternatively, the orthographic projection of the third welding portion E121 on the base substrate 200 and the orthographic projection of the fourth welding portion E122 on the base substrate 200 may be located on the same side of the orthographic projection of the fourth connecting portion L4 on the base substrate 200. For example, the orthographic projection of the third welding portion E121 on the base substrate 200 and the orthographic projection of the fourth welding portion E122 on the base substrate 200 are both located on a side of the orthographic projection of the fourth connecting portion L4 on the base substrate close to the display region AA.

In some specific embodiments, the orthographic projection of the third welding portion E121 on the base substrate 200 and the orthographic projection of the fourth welding portion E122 on the base substrate 200 are located on different sides of the orthographic projection of the third connecting portion L3 on the base substrate 200, and the orthographic projection of the third welding portion E121 on the base substrate 200 is spaced apart from the orthographic projection of the fourth welding portion E122 on the base substrate 200.

In the embodiments of the present disclosure, the orthographic projection of the third welding portion E121 on the base substrate 200 and the orthographic projection of the fourth welding portion E122 on the base substrate 200 may be located on two adjacent sides of the orthographic projection of the fourth connecting portion L4 on the base substrate 200. For example, the orthographic projection of the third welding portion E121 on the base substrate 200 is located on a side of the orthographic projection of the fourth connecting portion L4 on the base substrate 200 close to the display region AA, and the orthographic projection of the fourth welding portion E122 on the base substrate 200 is located on a side of the orthographic projection of the fourth connecting portion L4 on the base substrate 200 close to the binding region DP. Referring to FIG. 6, the third welding portion E121 is located on the right side of the fourth connecting portion L4, the connecting line body S2 is connected to the lower side of the fourth connecting portion L4, and the fourth welding portion E122 is located below the fourth connecting portion L4. In this way, on the one hand, an effective welding of the third welding portion E121 and the fourth welding portion E122 may be ensured, and on the other hand, a sufficient distance between the third welding portion E121, the fourth welding portion E122 and other signal lines may be kept, so as to prevent the third welding portion E121 and the fourth welding portion E122 from being short-circuited with other signal lines.

Optionally, the fourth welding portion E122 may be a rectangle, and the orthographic projection of the third welding portion E121 on the base substrate 200 overlaps with a rectangle corner of the orthographic projection of the fourth connecting portion L4 on the base substrate 200.

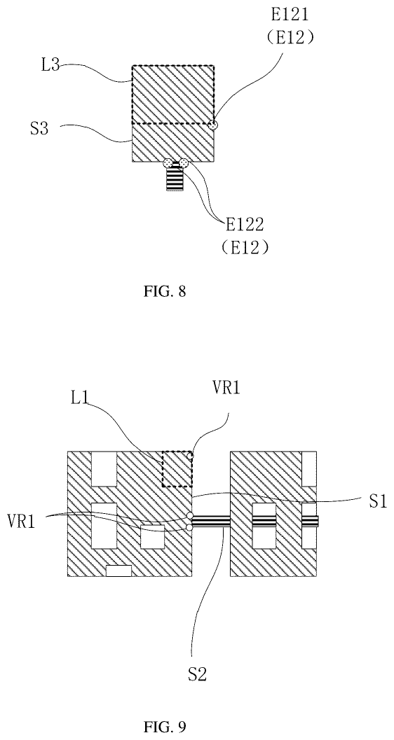

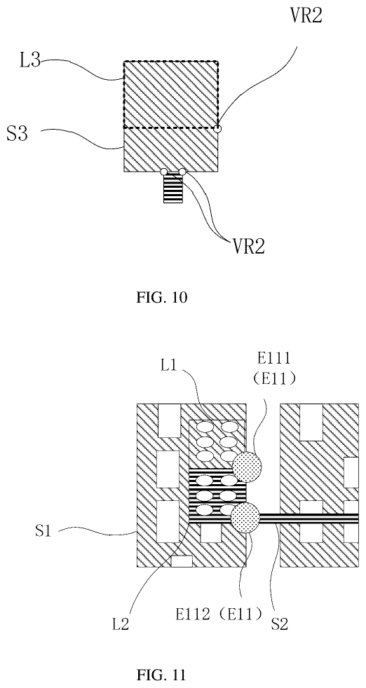

FIG. 7 schematically shows a first plan view of the first welding structure according to an embodiment of the present disclosure, FIG. 8 schematically shows a first plan view of the second welding structure according to an embodiment of the present disclosure, FIG. 9 schematically shows a plan view of a first welding hole according to an embodiment of the present disclosure, and FIG. 10 schematically shows a plan view of a second welding hole according to an embodiment of the present disclosure, where FIG. 7 (and FIG. 8) shows a surface of the initiation signal line (and the initiation signal lead) away from the base substrate 200, and FIG. 9 (and FIG. 10) shows a surface of the initiation signal line (and the initiation signal lead) close to the base substrate 200.

Referring to FIG. 7 to FIG. 10, in some specific embodiments, a material of the first welding structure E11 and the second welding structure E12 may include a solid welding material. The first welding structure E11 may weld the initiation signal line STV and the first connecting line 230 together through at least one first welding hole VR1, and the second welding structure E12 may weld the initiation signal lead STVY and the first connecting line 230 together through at least one second welding hole VR2. A hole diameter of the at least one first welding hole VR1 and a hole diameter of the at least one second welding hole VR2 are less than or equal to a line width of the first connecting line 230.

In the embodiments of the present disclosure, the material of the first welding structure E11 and the material of the second welding structure E12 are the same material, and may include metal powder. For example, the material of the first welding structure E11 and the second welding structure E12 include tungsten powder. The first welding hole and the second welding hole may be formed by a first laser beam. For example, a wavelength of the first laser beam may range from 900 nm to 1200 nm, such as 1064 nm. The first welding hole and the second welding hole formed by such laser beam have a small hole diameter, and for example, the hole diameter of the first welding hole and the hole diameter of the second welding hole are less than or equal to 10 μm.

In the embodiments of the present disclosure, the first welding structure E11 may weld the initiation signal line STV and the first connecting line 230 together through a plurality of first welding holes VR1. Specifically, the first connecting portion L1 and the second connecting portion L2 are arranged in the second direction Y, and the connecting line body S2 and the second connecting portion L2 are arranged in the first direction X. A first welding hole VR1 is formed at a junction between the first connecting portion L1 and the second connecting portion L2 in the second direction Y, and another first welding hole VR1 is formed at a junction between the connecting line body S2 and the second connecting portion L2 in the first direction X. The first laser beam may drill holes from a back side of the display substrate to form the first welding hole VR1 and the second welding hole VR2. For example, the first welding hole VR1 formed at the junction between the first connecting portion L1 and the second connecting portion L2 may penetrate the first connecting portion L1 and partially expose the second connecting portion L2, and the first welding hole VR1 formed at the junction between the connecting line body S2 and the second connecting portion L2 may penetrate the signal line body S1 and partially expose the connecting line body S2.

Afterwards, tungsten powder may be filled into the two first welding holes VR1 to conduct the first connecting portion L1 and the second connecting portion L2 and to conduct the signal line body S1 and the connecting line body S2. Then, the tungsten powder in the two first welding holes VR1 may be heated for welding, thereby forming the first welding portion E11 and the second welding portion E112. Since the hole diameter of the first welding hole VR1 is less than or equal to 10 μm, the first welding portion E111 and the second welding portion E112 formed may occupy a small space. For example, either the first welding portion E111 or the second welding portion E112 has a diameter less than or equal to 10 μm.

In the embodiments of the present disclosure, the second welding structure E12 may weld the initiation signal lead STVY and the first connecting line 230 together through a plurality of second welding holes VR2. Specifically, the third connecting portion L3 and the fourth connecting portion L4 are arranged in the second direction Y, a second welding hole VR2 is formed at a junction between the third connecting portion L3 and the fourth connecting portion L4 in the second direction Y, and the second welding hole VR2 penetrates the third connecting portion L3 and partially exposes the fourth connecting portion L4. The connecting line body S2 and the fourth connecting portion L4 are arranged in the second direction Y, a second welding hole VR2 is formed at a junction between the connecting line body S2 and the fourth connecting portion L4 in the second direction Y, and the second welding hole VR2 penetrates the lead body S3 and partially exposes the connecting line body S2.

Afterwards, tungsten powder may be filled into the two second welding holes VR2 to conduct the third connecting portion L3 and the fourth connecting portion L4 and to conduct the lead body S3 and the connecting line body S2. Then, the tungsten powder in the two second welding holes VR2 may be heated for welding, thereby forming the third welding portion E121 and the fourth welding portion E122. Since the hole diameter of the second welding hole VR2 is less than or equal to 10 μm, the third welding portion E121 and the fourth welding portion E122 formed may occupy a small space. For example, either the third welding portion E121 or the fourth welding portion E122 has a diameter less than or equal to 10 μm.

In some specific embodiments, the orthographic projection of at least one first welding hole VR1 on the base substrate 200 and the orthographic projection of at least one second welding hole VR2 on the base substrate 200 overlap at least partially with the orthographic projection of the first connecting line 230 on the base substrate 200.

In the embodiments of the present disclosure, the first welding hole VR1 formed may penetrate the first connecting portion L1 and the signal line body S1, and expose a surface of the first connecting line 230 close to the base substrate 200. For example, the two first welding holes VR1 respectively expose a surface of the second connecting portion L2 close to the base substrate 200 and a surface of the connecting line body S2 close to the base substrate 200. The second welding hole VR2 formed may penetrate the third connecting portion L3 and the lead body S3, and expose a surface of the first connecting line 230 close to the base substrate 200. For example, the two second welding holes VR2 respectively expose a surface of the fourth connecting portion L4 close to the base substrate 200 and a surface of the connecting line body S2 close to the base substrate 200.

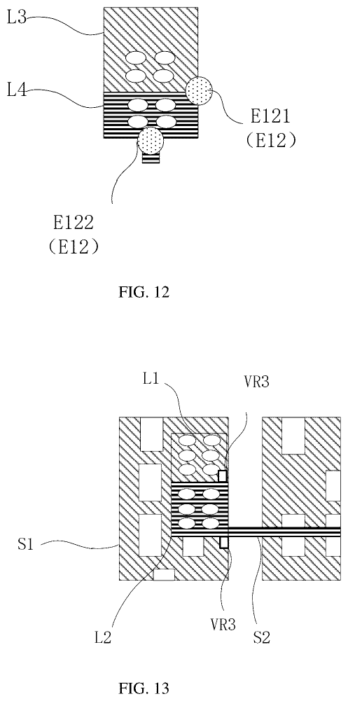

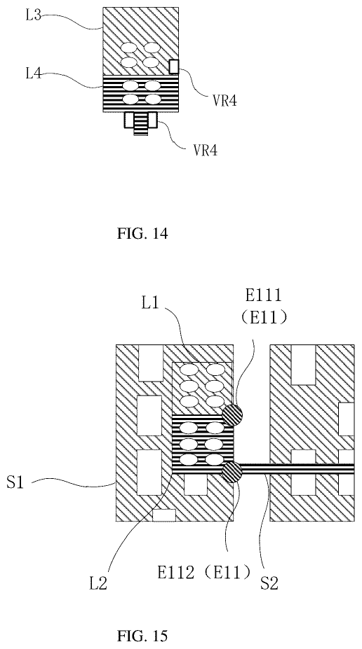

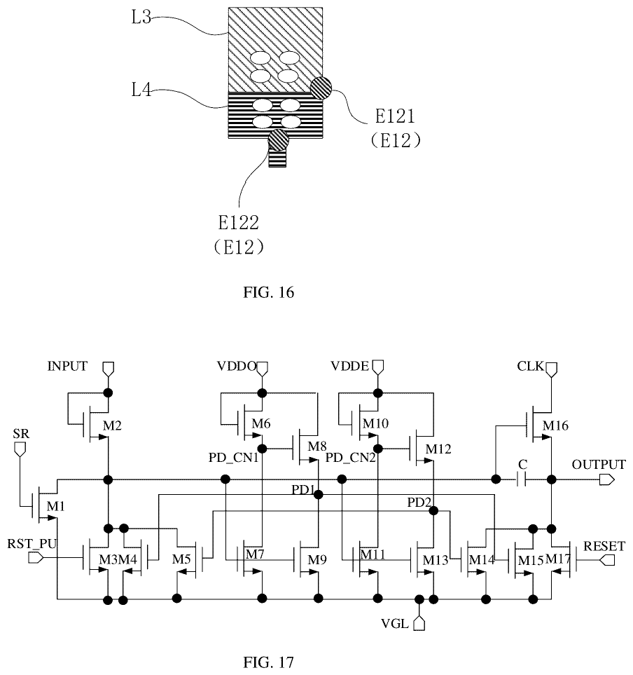

FIG. 11 schematically shows a second plan view of the first welding structure according to an embodiment of the present disclosure, FIG. 12 schematically shows a second plan view of the second welding structure according to an embodiment of the present disclosure, FIG. 13 schematically shows a plan view of a third welding hole according to an embodiment of the present disclosure, FIG. 14 schematically shows a plan view of a fourth welding hole according to an embodiment of the present disclosure, FIG. 15 schematically shows a third plan view of the first welding structure according to an embodiment of the present disclosure, and FIG. 16 schematically shows a third plan view of the second welding structure according to an embodiment of the present disclosure, where a surface of the initiation signal line (or the initiation signal lead) away from the base substrate 200 is shown in FIG. 11 to FIG. 16.

Referring to FIG. 11 to FIG. 16, in some specific embodiments, the material of the first welding structure E11 and the second welding structure E12 includes a solid welding material or a liquid welding material. The first welding structure E11 may weld the initiation signal line STV and the first connecting line 230 together through a third welding hole VR3, and the second welding structure E12 may weld the initiation signal lead STVY and the first connecting line 230 together through a fourth welding hole VR4. A hole diameter of the third welding hole VR3 and a hole diameter of the fourth welding hole VR4 are greater than the line width of the first connecting line 230.

In other embodiments, the hole diameter of the third welding hole VR3 and the hole diameter of the fourth welding hole VR4 may not be greater than the line width of the first connecting line 230, but may be greater than the hole diameter of the first welding hole VR1 and the hole diameter of the second welding hole VR2.

In the embodiments of the present disclosure, the first welding structure E11 and the second welding structure E12 include the same material, and optionally, may include a solid welding material. For example, the first welding structure E11 and the second welding structure E12 both include tungsten powder. Optionally, the first welding structure E11 and the second welding structure E12 may include a liquid welding material. For example, the first welding structure E11 and the second welding structure E12 both include a silver solution, such as printing ink (INK) including silver.

The first welding hole VR1 and the second welding hole VR2 may be formed by a second laser beam, and the second laser beam may include a pulsed laser beam such as a picosecond laser beam or a femtosecond laser beam. A wavelength of the second laser beam may range from 400 nm to 600 nm, such as 532 nm. The first welding hole VR1 and the second welding hole VR2 formed using such laser beam may have a large hole diameter. For example, the hole diameter of the first welding hole VR1 and the second welding hole VR2 may be greater than or equal to 10 μm.

Different from the aforementioned embodiments, the first welding hole VR1 and the second welding hole VR2 formed by the second laser beam may have a large hole diameter, therefore, in addition to a solid welding material, a liquid welding material may also be used for the first welding structure E11 and the second welding structure E12. This is because the large hole diameter allows the liquid welding material to be fully heated, so that the liquid welding material may reach a desired degree of curing so as to achieve welding.

In the following, a process of manufacturing the first welding structure E11 and the second welding structure E12 using a solid welding material in the embodiments will be described below firstly.

In the embodiments of the present disclosure, the first welding structure E11 may weld the initiation signal line STV and the first connecting line 230 together through a plurality of third welding holes VR3. Specifically, the first connecting portion L1 and the second connecting portion L2 are arranged in the second direction Y, and the connecting line body S2 and the second connecting portion L2 are arranged in the first direction X. A third welding hole VR3 is formed at a junction between the first connecting portion L1 and the second connecting portion L2 in the second direction Y, and another third welding hole VR3 is formed at a junction between the connecting line body S2 and the second connecting portion L2 in the first direction X.

Different from the aforementioned embodiments, the second laser beam may selectively peel off a film layer from the display substrate without damaging other film layers. For example, it is possible to selectively peel off the insulation layer between the first connecting portion L1 and the second connecting portion L2 without damaging the first connecting portion L1 and the second connecting portion L2 (or the connecting line body S2). Therefore, in the embodiments, the third welding hole VR3 formed at the junction between the first connecting portion L1 and the second connecting portion L2 may only expose a surface on one side of the first connecting portion L1 (such as the surface away from the base substrate 200), rather than penetrating the first connecting portion L1. Optionally, the third welding hole VR3 formed at the junction between the first connecting portion L1 and the second connecting portion L2 may be arranged adjacent to the second connecting portion L2.

Accordingly, the third welding hole VR3 formed at the junction between the connecting line body S2 and the second connecting portion L2 may only expose a surface on one side of the signal line body S1 (such as the surface away from the base substrate 200), rather than penetrating the signal line body S1. Optionally, the third welding hole VR3 formed at the junction between the connecting line body S2 and the second connecting portion L2 may be arranged adjacent to the connecting line body S2.

In some specific embodiments, the first welding structure E11 is in contact with the surface of the first connecting line 230 away from the base substrate 200. For example, after two third welding holes VR3 are formed, tungsten powder may be filled into the two third welding holes VR3. The tungsten powder covers a surface of the first connecting portion L1 away from the base substrate 200 and a surface of the second connecting portion L2 away from the base substrate 200, thereby conducting the first connecting portion L1 and the second connecting portion L2. Furthermore, the tungsten powder covers the surface of the first connecting portion L1 away from the base substrate 200 and a surface of the connecting line body S2 away from the base substrate 200, thereby conducting the signal line body S1 and the connecting line body S2. Then, the tungsten powder in the two third welding holes VR3 is heated for welding, thereby forming the first welding portion E111 and the second welding portion E112. Since the hole diameter of the first welding hole VR1 is greater than or equal to 10 μm, the first welding portion E111 and the second welding portion E112 formed may occupy a large space. Compared with the aforementioned embodiments, the first welding portion E111 and the second welding portion E112 in the embodiment have a larger connection area, which may further reduce the connection impedance and thus have a better improvement effect on the electrostatic accumulation.

In the embodiments of the present disclosure, the second welding structure E12 may weld the initiation signal lead STVY and the first connecting line 230 together through a plurality of fourth welding holes VR4. Specifically, the third connecting portion L3 and the fourth connecting portion L4 are arranged in the second direction Y, and the connecting line body S2 and the fourth connecting portion L4 are arranged in the second direction Y. A fourth welding hole VR4 is formed at a junction between the third connecting portion L3 and the fourth connecting portion L4 in the second direction Y, and another fourth welding hole VR4 is formed at a junction between the connecting line body S2 and the fourth connecting portion L4 in the second direction Y.

Different from the aforementioned embodiments, the second laser beam may selectively peel off a film layer from the display substrate without damaging other film layers. For example, it is possible to selectively peel off the insulation layer between the third connecting portion L3 and the fourth connecting portion L4 without damaging the third connecting portion L3 and the fourth connecting portion L4 (or the connecting line body S2). Therefore, in the embodiments, the second welding hole VR2 formed at the junction between the third connecting portion L3 and the fourth connecting portion L4 may only expose a surface on one side of the third connecting portion L3 (such as the surface away from the base substrate 200), rather than penetrating the third connecting portion L3. Optionally, the fourth welding hole VR4 formed at the junction between the third connecting portion L3 and the fourth connecting portion L4 may be arranged adjacent to the fourth connecting portion L4.

Accordingly, the fourth welding hole VR4 formed at the junction between the connecting line body S2 and the fourth connecting portion L4 may only expose a surface on one side of the lead body S3 (such as a side surface of the lead body S3 and/or a surface of the lead body S3 away from the base substrate 200), rather than penetrating the lead body S3. Optionally, the second welding hole VR2 formed at the junction between the connecting line body S2 and the fourth connecting portion L4 may be arranged adjacent to the connecting line body S2.

In some specific embodiments, the second welding structure E12 is in contact with a surface of the first connecting line 230 away from the base substrate 200. For example, after two fourth welding holes VR4 are formed, tungsten powder may be filled into the two fourth welding holes VR4. The tungsten powder covers a surface of the third connecting portion L3 away from the base substrate 200 and a surface of the fourth connecting portion L4 away from the base substrate 200, thereby conducting the third connecting portion L3 and the fourth connecting portion L4. Furthermore, the tungsten powder covers a side surface of the lead body S3 (and/or a surface of the lead body S3 away from the base substrate 200) and the surface of the connecting line body S2 away from the base substrate 200, thereby conducting the lead body S3 and the connecting line body S2. Then, the tungsten powder in the two fourth welding holes VR4 may be heated for welding, thereby forming the third welding portion E121 and the fourth welding portion E122. Since the hole diameter of the fourth welding hole VR4 is greater than or equal to 10 um, the third welding portion E121 and the fourth welding portion E122 formed may occupy a large space. Compared to the aforementioned embodiments, the third welding portion E121 and the fourth welding portion E122 in the embodiment have a larger connection area, which may further reduce the connection impedance and thus have a better improvement effect on the electrostatic accumulation.

In some specific embodiments, each of the first welding structure E11 and the second welding structure E12 is in contact with the surface of the first connecting line 230 away from the base substrate 200.

Then, a process of manufacturing the first welding structure E11 and the second welding structure E12 using a liquid welding material in the embodiments will be described below.

In the embodiments of the present disclosure, the first welding structure E11 may weld the initiation signal line STV and the first connecting line 230 together through a plurality of third welding holes VR3. Specifically, the first connecting portion L1 and the second connecting portion L2 are arranged in the second direction Y, and the connecting line body S2 and the second connecting portion L2 are arranged in the first direction X. A third welding hole VR3 is formed at a junction between the first connecting portion L1 and the second connecting portion L2 in the second direction Y, and another third welding hole VR3 is formed at a junction between the connecting line body S2 and the second connecting portion L2 in the first direction X.

The second laser beam may selectively peel off a film layer from the display substrate without damaging other film layers. For example, it is possible to selectively peel off the insulation layer between the first connecting portion L1 and the second connecting portion L2 without damaging the first connecting portion L1 and the second connecting portion L2 (or the connecting line body S2). Therefore, in the embodiments, the third welding hole VR3 formed at the junction between the first connecting portion L1 and the second connecting portion L2 may only expose the surface of the first connecting portion L1 away from the base substrate 200. Optionally, the third welding hole VR3 formed at the junction between the first connecting portion L1 and the second connecting portion L2 may be arranged adjacent to the second connecting portion L2.

Accordingly, the third welding hole VR3 formed at the junction between the connecting line body S2 and the second connecting portion L2 may only expose a surface of the signal line body S1 away from the base substrate 200. Optionally, the third welding hole VR3 formed at the junction between the connecting line body S2 and the second connecting portion L2 may be arranged adjacent to the connecting line body S2.

Afterwards, a silver solution may be filled into the two first welding holes VR1. The silver solution covers the surface of the first connecting portion L1 away from the base substrate 200 and the surface of the second connecting portion L2 away from the base substrate 200, thereby conducting the first connecting portion L1 and the second connecting portion L2. Furthermore, the silver solution covers the surface of the signal line body SI away from the base substrate 200 and the surface of the connecting line body S2 away from the base substrate 200, thereby conducting the signal line body S1 and the connecting line body S2. Then, the silver solution in the two third welding holes VR3 may be heated for welding, thereby forming the third welding portion E121 and the fourth welding portion E122. A heating temperature may range from 150° C. to 250° C., such as 200° C., and a heating duration may range from 4 s to 12 s, such as 8 s. Compared with the aforementioned embodiments, it is possible to remove excess silver solution by a laser beam, thereby preventing the first welding portion E111 and the second welding portion E112 finally formed from being short-circuited with other signal lines.

In the embodiments of the present disclosure, the second welding structure E12 may weld the initiation signal lead STVY and the first connecting line 230 together through a plurality of fourth welding holes VR4. Specifically, the third connecting portion L3 and the fourth connecting portion L4 are arranged in the second direction Y, and the connecting line body S2 and the fourth connecting portion L4 are arranged in the second direction Y. A fourth welding hole VR4 is formed at a junction between the third connecting portion L3 and the fourth connecting portion L4 in the second direction Y, and another fourth welding hole VR4 is formed at a junction between the connecting line body S2 and the fourth connecting portion L4 in the second direction Y.

The second laser beam may selectively peel off a film layer from the display substrate without damaging other film layers. For example, it is possible to selectively peel off the insulation layer between the third connecting portion L3 and the fourth connecting portion L4 without damaging the third connecting portion L3 and the fourth connecting portion L4 (or the connecting line body S2). Therefore, in the embodiments, the fourth welding hole VR4 formed at the junction between the third connecting portion L3 and the fourth connecting portion L4 may only expose the surface of the third connecting portion L3 away from the base substrate 200. Optionally, the fourth welding hole VR4 formed at the junction between the third connecting portion L3 and the fourth connecting portion L4 may be arranged adjacent to the fourth connecting portion L4.

That is to say, in the embodiments of the present disclosure, an orthographic projection of the third welding hole VR3 on the base substrate 200 and an orthographic projection of the fourth welding hole VR4 on the base substrate 200 are spaced apart from the orthographic projection of the first connecting line 230 on the base substrate 200.

Accordingly, the fourth welding hole VR4 formed at the junction between the connecting line body S2 and the fourth connecting portion L4 only exposes a side surface of the lead body S3 (such as a side surface of the lead body S3 and/or a surface of the lead body S3 from the base substrate 200). Optionally, the fourth welding hole VR4 formed at the junction between the connecting line body S2 and the fourth connecting portion L4 may be arranged adjacent to the connecting line body S2.

Afterwards, a silver solution may be filled into the two fourth welding holes VR4. The silver solution covers the surface of the third connecting portion L3 away from the base substrate 200 and the surface of the fourth connecting portion L4 away from the base substrate 200, thereby conducting the third connecting portion L3 and the fourth connecting portion L4. Furthermore, the silver solution covers a side surface of the lead body S3 (and/or the surface of the lead body S3 away from the base substrate 200) and the surface of the connecting line body S2 away from the base substrate 200, thereby conducting the lead body S3 and the connecting line body S2. Then, the silver solution in the two fourth welding holes VR4 may be heated for welding, thereby forming the third welding portion E121 and the fourth welding portion E122. Compared to the aforementioned embodiments, it is possible to remove excess silver solution by the laser beam, thereby preventing the third welding portion E121 and the fourth welding portion E122 finally formed from being short-circuited with other signal lines.

Through the anti-static structure E in the first position 251, an anti-static effect may be improved from 14˜15 KV (without providing any anti-static structure E in the embodiments of the present disclosure) to 25˜29 KV.

The anti-static structure E in the second position 252 in the embodiments of the present disclosure will be described below.

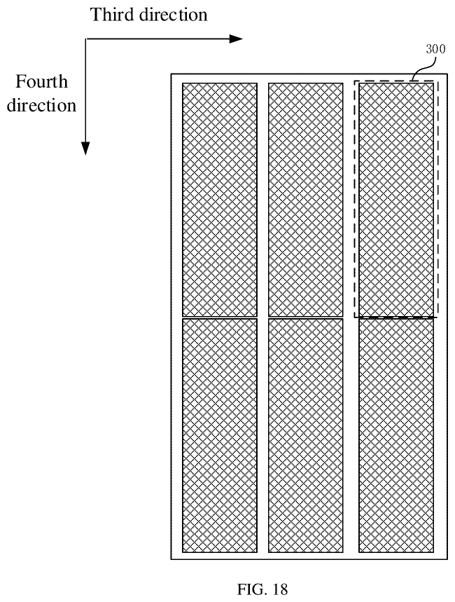

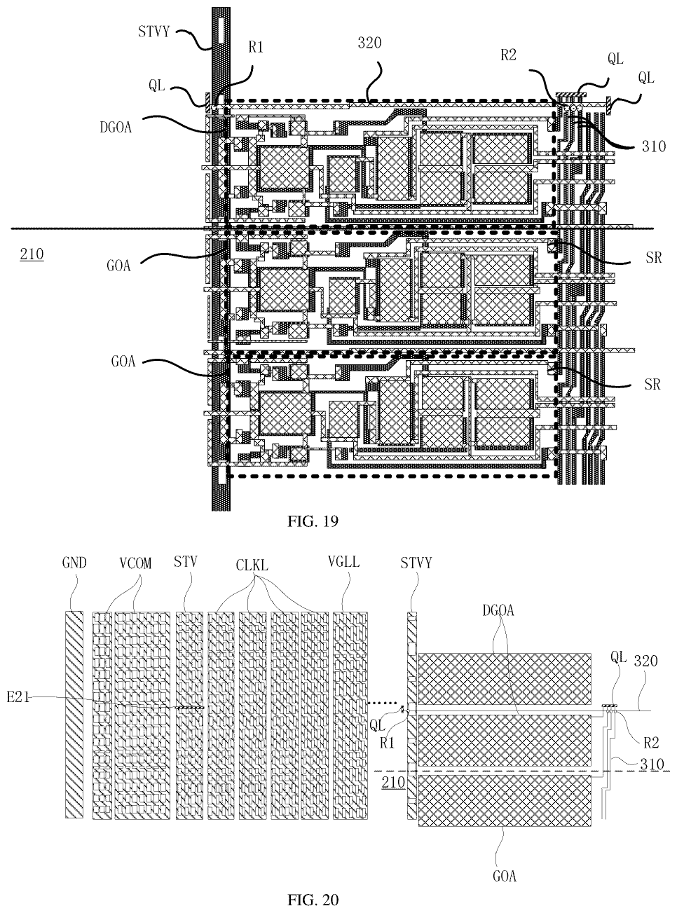

FIG. 17 schematically shows an equivalent circuit diagram of a shift register unit according to an embodiment of the present disclosure, FIG. 18 schematically shows a first schematic diagram of a display motherboard according to an embodiment of the present disclosure, and FIG. 19 schematically shows a plan view of positions of the third welding structure and the fourth welding structure according to an embodiment of the present disclosure.

A circuit of the shift register unit GOA involved in the embodiments of the present disclosure will be introduced below with reference to FIG. 17.

The shift register unit GOA in the embodiments of the present disclosure includes a first transistor M1, a second transistor M2, a third transistor M3, a fourth transistor M4, a fifth transistor M5, a sixth transistor M6, a seventh transistor M7, an eighth transistor M8, a ninth transistor M9, a tenth transistor M10, an eleventh transistor M11, a twelfth transistor M12, a thirteenth transistor M13, a fourteenth transistor M14, a fifteenth transistor M15, a sixteenth transistor M16, a seventeenth transistor M17, and a capacitor C.

The first transistor M1 has a gate electrode connected to a first input terminal SR, a first terminal connected to a pull-up position PU, and a second terminal connected to a first voltage terminal VGL.

The second transistor M2 has a gate electrode connected to a data input terminal INPUT, a first terminal connected to the data input terminal INPUT, and a second terminal connected to the pull-up position PU.

The third transistor M3 has a gate electrode connected to a pull-up position reset terminal RST-PU, a first terminal connected to the pull-up position PU, and a second terminal connected to the first voltage terminal VGL.

The sixteenth transistor M16 has a gate electrode connected to the pull-up position PU, a first terminal connected to a clock signal terminal CLK, and a second terminal connected to a first output terminal OUTPUT.

The fourth transistor M4 has a gate electrode connected to a first pull-down position PD1, a first terminal connected to the first terminal of the third transistor M3, and a second terminal connected to a second voltage terminal VGL.

The fifth transistor M5 has a gate electrode connected to a second pull-down position PD2, a first terminal connected to the first terminal of the fourth transistor M4, and a second terminal connected to the second voltage terminal VGL.

The sixth transistor M6 has a gate electrode connected to a third voltage terminal VDDO, a first terminal connected to the third voltage terminal VDDO, and a second terminal connected to a third pull-down position PD_CN1.

The seventh transistor M7 has a gate electrode connected to the pull-up position PU, a first terminal connected to the second terminal of the sixth transistor M6, and a second terminal connected to the second voltage terminal VGL.

The eighth transistor M8 has a gate electrode connected to the second terminal of the sixth transistor M6, a first terminal connected to the third voltage terminal VDDO, and a second terminal connected to the first pull-down position PD1.

The ninth transistor M9 has a gate electrode connected to the pull-up position PU, a first terminal connected to the second terminal of the eighth transistor M8, and a second terminal connected to the second voltage terminal VGL.

The tenth transistor M10 has a gate electrode connected to a fourth voltage terminal VDDE, a first terminal connected to the fourth voltage terminal VDDE, and a second terminal connected to a fourth pull-down position PD_CN2.

The eleventh transistor M11 has a gate electrode connected to the pull-up position PU, a first terminal connected to the second terminal of the tenth transistor M10, and a second terminal connected to the second voltage terminal VGL.

The twelfth transistor M12 has a gate electrode connected to the second terminal of the tenth transistor M10, a first terminal connected to the fourth voltage terminal VDDE, and a second terminal connected to the second pull-down position PD2.

The thirteenth transistor M13 has a gate electrode connected to the pull-up position PU, a first terminal connected to the second terminal of the twelfth transistor M12, and a second terminal connected to the second voltage terminal VGL.

The seventeenth transistor M17 has a gate electrode connected to a reset voltage terminal RESET, a first terminal connected to the first output terminal OUTPUT, and a second terminal connected to the second voltage terminal VGL.

The fifteenth transistor M15 has a gate electrode connected to the first pull-down position PD1, a first terminal connected to the first terminal of the seventeenth transistor M17, and a second terminal connected to the second voltage terminal VGL.

The fourteenth transistor M14 has a gate electrode connected to the second pull-down position PD2, a first terminal connected to the first terminal of the fifteenth transistor M15, and a second terminal connected to the second voltage terminal VGL.

The capacitor C has a first terminal connected to the pull-up position PU and a second terminal connected to the first output terminal OUTPUT.

In the embodiments of the present disclosure, any transistor in the shift register unit GOA may be an N-type transistor or a P-type transistor, which may be selected according to the actual situation. The first terminal of the transistor is a source electrode or a drain electrode, and the second terminal of the transistor is a drain electrode or a source electrode corresponding to the first terminal.

Referring to FIG. 18, the display motherboard includes a plurality of first substrate regions 300 arranged in the third direction and the fourth direction, and the initiation signal lines and the initiation signal leads on the display motherboard extend in the fourth direction. After the display motherboard is cut along the third direction (for example, by a rough cutting step and/or a fine cutting step), some signal lines in some first substrate regions 300 may be cut off, as shown by a cutting line QL in FIG. 19.

In order to ensure that initiation input terminals of the first N stages of shift register units GOA in the gate driving circuit 210 may receive initiation signals normally, in the embodiments of the present disclosure, it is required to re-weld the initiation input terminals of the first N stages of shift register units GOA with the initiation signal line STV and the initiation signal lead STVY.

Referring to FIG. 19, specifically, the display substrate further includes a plurality of third connecting lines 310 and at least one fourth connecting line 320 that are provided on the base substrate 200 and located in the side region CB. The plurality of third connecting lines 310 extend in the second direction Y, the at least one fourth connecting line 320 extends in the first direction X, and the plurality of third connecting lines 310 are located on a side of the gate driving circuit 210 away from the initiation signal lead STVY. At least one stage of shift register unit GOA includes a first input terminal SR, the first input terminals SR of the first N stages of shift register units GOA are electrically connected to the plurality of third connecting lines 310, and the first input terminals SR of different stages of shift register units GOA are electrically connected to different third connecting lines 310. The initiation signal lead STVY is electrically connected to the plurality of third connecting lines 310 through the at least one fourth connecting line 320, where N is a natural number.

The first N stages of shift register units GOA may refer to first three stages of shift register units GOA. The fourth connecting line 320 may be arranged in the same layer and include the same material as the first connecting line 230. For example, the fourth connecting line 320 is located in the second conductive layer 262. The first input terminals SR of the first three stages of shift register units GOA may be electrically connected to the initiation signal lead STVY through a bridging connection of the fourth connecting line 320, so that an initiation signal on the initiation signal lead STVY may be transmitted to the first input terminals SR of the first three stages of shift register units GOA.

It should be noted that in the embodiments of the present disclosure, the shift register units GOA in the gate driving circuit 210 refer to valid shift register units GOA, that is, the shift register units GOA of the gate driving circuit 210 may output scanning signals sequentially according to a cascade relationship when the display substrate is working.

FIG. 20 schematically shows a plan view of a position of a partition structure according to an embodiment of the present disclosure.

Referring to FIG. 19 and FIG. 20, in some specific embodiments, the display substrate further includes a ground signal line GND, a common voltage signal line VCOM, a plurality of clock signal lines CLKL, and a first voltage signal line VGLL. At least one of the plurality of clock signal lines CLKL is electrically connected to a clock signal terminal CLK in the shift register unit GOA, and the first voltage signal line VGLL is electrically connected to a second voltage terminal VGL in the shift register unit GOA. In the first direction X, the initiation signal line STV is located between the common voltage signal line VCOM and the clock signal line CLKL.

In some specific embodiments, the anti-static structure E in the second position 252 includes a partition structure E21. On the plurality of first signal lines 220, a portion on a side of the partition structure E21 close to the binding opposite region DPO is spaced apart from a portion on a side of the partition structure E21 close to the binding region DP by the partition structure E21. The initiation signal lead STVY is welded with the at least one fourth connecting line 320 through a third welding structure R1, and the at least one fourth connecting line 320 is welded with the plurality of third connecting lines 310 through a fourth welding structure R2. The partition structure E21, the third welding structure R1 and the fourth welding structure R2 are within a predetermined range, and the predetermined range is less than or equal to a range defined by a laser operation window.

In the embodiments of the present disclosure, a method of manufacturing the third welding structure R1 and the fourth welding structure R2 may be the same as the method of manufacturing the first welding structure E11 and the second welding structure E12. Therefore, a morphology of the third welding structure R1 and the fourth welding structure R2 may be determined with reference to the first welding structure E11 and the second welding structure E12, which will not be described in detail in the embodiments of the present disclosure.

The laser operation window is configured such that a portion in the laser operation window may be formed through one and same step of laser cutting (or welding) process. For example, when cutting excess signal lines, it is possible to synchronously form the partition structure E21 in the second position 252. In this way, compared to the welding structure in the aforementioned embodiments, the partition structure E21 may be formed without adding additional process steps, so that the manufacturing process may be simplified.

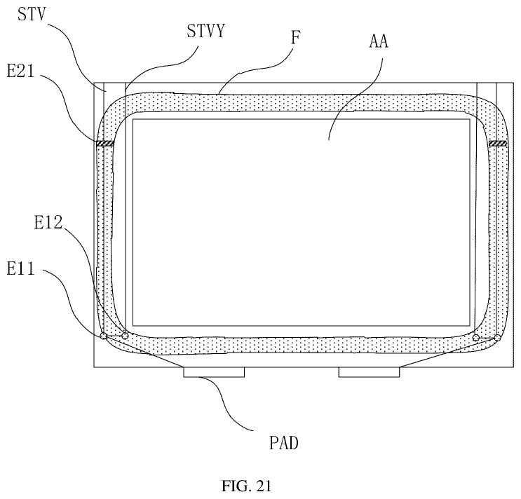

FIG. 21 schematically shows a plan view of a sealant and the partition structure according to an embodiment of the present disclosure.

Referring to FIG. 21, in some specific embodiments, the display substrate further includes a sealant F on the base substrate 200. An orthographic projection of the partition structure E21 on the base substrate 200 falls within the side region CB, and an orthographic projection of the sealant F on the base substrate 200 covers the orthographic projection of the partition structure E21 on the base substrate 200. In this way, it may be ensured that the partition structure E21 is covered by the sealant F, rather than being exposed by the sealant F due to fluctuations in a coating process of the sealant F. In this way, the static electricity introduced by the initiation signal line STV exposed by the sealant F may be blocked, so that the electrostatic accumulation at the connection between the initiation signal line STV and the initiation signal lead STVY may be better improved.

For example, the sealant F includes two first portions extending in the first direction X, two second portions extending in the second direction Y, and four corner portions between the first portions and the second portions. The two first portions, the two second portions and the four corner portions may enclose a closed structure that surrounds the outer periphery of the display region AA. The two first portions are located in the binding region DP and the binding opposite region DPO respectively, and the two second portions are located in the side region CB. Optionally, in the second direction Y, a distance between the second portion and the binding opposite region DPO may range from 2800 μm to 3700 μm, a distance between the third welding structure R1 and the binding opposite region DPO and a distance between the fourth welding structure R2 and the binding opposite region DPO may be set to 5400 μm, and a distance between the partition structure E21 and the binding opposite region DPO may range from 3700 μm to 5400 μm.

In some specific embodiments, the display substrate further includes a plurality of invalid shift register units DGOA. In the second direction Y, the plurality of invalid shift register units DGOA are located on a side of the gate driving circuit 210 close to the binding opposite region DPO. The partition structure E21, the third welding structure R1 and the fourth welding structure R2 are located between two invalid shift register units DGOA adjacent in the second direction Y.

For example, referring to FIG. 20, two shift register units are provided above the first stage of shift register unit GOA, and the relevant signal lines of these shift register units are cut off. Accordingly, when the display substrate is working, these shift register units may not output scanning signals to the display region AA. Therefore, in the embodiments of the present disclosure, these shift register units are referred to as invalid shift register units DGOA. In the embodiments of the present disclosure, the partition structure E21, the third welding structure R1 and the fourth welding structure R2 are arranged between two invalid shift register units DGOA, so that the first stage of shift register unit GOA may be electrically connected to the corresponding signal lines, and that the partition structure E21, the third welding structure R1 and the fourth welding structure R2 may not affect existing structures.

It should be noted that the above is described taking the initiation signal line STV, the initiation signal lead STVY and the anti-static structure E located on a side of the display region AA as an example. In some embodiments, it is possible to provide the initiation signal lines STV, the initiation signal leads STVY and the anti-static structures E on two opposite sides of the display region AA, and the initiation signal lines STV, the initiation signal leads STVY and the anti-static structures E on the two opposite sides of the display region AA may be substantially the same, which will not be described in detail in the embodiments of the present disclosure.

Through the anti-static structure E in the second position 252, the anti-static effect may be improved from 14˜15 KV (without providing any anti-static structure E in the embodiments of the present disclosure) to 19˜25 KV.

In some specific embodiments, the anti-static structures E may be simultaneously provided in the first position 251 and the second position 252. In the embodiments, the anti-static effect may be improved from 14˜15 KV (without providing any anti-static structure E in the embodiments of the present disclosure) to 23˜29 KV.

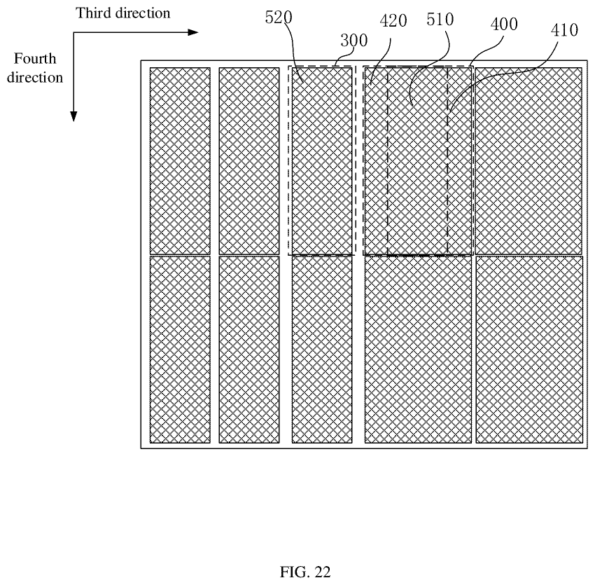

FIG. 22 schematically shows a second plan view of the display motherboard according to an embodiment of the present disclosure.

Referring to FIG. 22, at least some embodiments of the present disclosure further provide a display motherboard, which includes a first substrate region 300 and a second substrate region 400. The first substrate region 300 is used to manufacture the aforementioned display substrate.

The first substrate region 300 and the second substrate region 400 may have different sizes in the third direction. For example, the third direction is the same as the first direction X mentioned above. The second substrate region 400 includes a first sub-region 410 and a second sub-region 420 at least partially surrounding the first sub-region 410. The first sub-region 410 includes a fourth conductive layer 510, and the first substrate region 300 includes a fifth conductive layer 520. The fourth conductive layer 510 and the fifth conductive layer 520 are arranged in the same layer and include the same material. A pattern of the fourth conductive layer 510 is identical with a pattern of a portion of the fifth conductive layer 520 located in the first sub-region 410.

In the embodiments of the present disclosure, the first substrate region 300 and the second substrate region 400 have different sizes in the third direction, and therefore may be used to manufacture display substrates having different sizes. Optionally, the first substrate region 300 and the second substrate region 400 have the same size in the fourth direction, and the third direction intersects with the fourth direction. Exemplarily, the third direction may refer to a horizontal direction in the figure, and the fourth direction may refer to a vertical direction in the figure, that is, the third direction and the fourth direction are perpendicular to each other.

The fourth conductive layer 510 and the fifth conductive layer 520 may be formed based on one and same mask pattern. However, the fifth conductive layer 520 is manufactured based on a complete mask pattern, while the fourth conductive layer 510 is manufactured based on a pattern by partial blocking the mask pattern. In this way, one and same mask pattern may be multiplexed to expose the first substrate region 300 and the second substrate region 400, that is, one and same mask pattern may be multiplexed to manufacture display substrates having two sizes, so that the research and development costs of masks may be saved.

At least some embodiments of the present disclosure further provide a display panel, which includes the display substrate as described above. The display panel has a display region, a binding region, a binding opposite region, a side region, and related structures therein. For example, the display panel may be a liquid crystal display panel.

At least some embodiments of the present disclosure further provide a display device. The display device may include any apparatus or product having a display function. For example, the display device may be a smart phone, a mobile phone, an e-book reader, a desktop personal computer (PC), a laptop PC, a netbook PC, a personal digital assistant (PDA), a portable multimedia player (PMP), a digital audio player, a mobile medical apparatus, a camera, a wearable apparatus (such as a head-mounted apparatus, electronic clothing, electronic bracelet, electronic necklace, electronic accessory, electronic tattoo, or smart watch), a television, etc.

It should be understood that the display device according to the embodiments of the present disclosure has all the features and advantages of the above-mentioned display substrate and display panel. The details may be referred to the above descriptions and will not be repeated here.

1. A display substrate, comprising:
a display region, a binding region, a binding opposite region, a side region, a first corner region and a second corner region, wherein the side region and the display region are arranged in a first direction, the binding opposite region, the display region and the binding region are arranged in sequence in a second direction intersecting with the first direction, the first corner region is located between the side region and the binding opposite region and at least partially surrounds a first corner of the display region, and the second corner region is located between the side region and the binding region and at least partially surrounds a second corner of the display region;
a base substrate;
a gate driving circuit provided on the base substrate and located in the side region, wherein the gate driving circuit comprises multi-stage shift register units connected in cascade;
a plurality of first signal lines provided on the base substrate and located in the side region, the first corner region and the second corner region,
wherein the plurality of first signal lines are located on a side of the gate driving circuit away from the display region;
wherein the plurality of first signal lines comprise an initiation signal line and an initiation signal lead, the initiation signal lead is located on a side of the initiation signal line close to the gate driving circuit, and the initiation signal line and the initiation signal lead extend in the second direction and are electrically connected through a first connecting line in the second corner region; and
wherein the plurality of first signal lines are provided with an anti-static structure in at least one of a first position and a second position, the first position comprises a connection between the initiation signal line and the first connecting line and a connection between the initiation signal lead and the first connecting line, and the second position comprises a portion of the plurality of first signal lines on a side of a row where a first-stage shift register unit is located close to the binding opposite region.

2. The display substrate according to claim 1, wherein the anti-static structure in the first position comprises:
a first welding structure configured to weld the initiation signal line and the first connecting line together at the connection between the initiation signal line and the first connecting line; and/or
a second welding structure configured to weld the initiation signal lead and the first connecting line together at the connection between the initiation signal lead and the first connecting line.

3. The display substrate according to claim 2, wherein the display substrate comprises a first conductive layer, a second conductive layer on a side of the first conductive layer away from the base substrate, and a third conductive layer on a side of the second conductive layer away from the second conductive layer;
wherein the display substrate further comprises a first transfer structure in the third conductive layer, the initiation signal line is located in the first conductive layer, and the first connecting line is located in the second conductive layer;
wherein the initiation signal line comprises a first connecting portion and a signal line body, an orthographic projection of the first connecting portion on the base substrate overlaps at least partially with an orthographic projection of the first transfer structure on the base substrate, and the first connecting portion is electrically connected to the first transfer structure in an overlapping region of the first connecting portion and the first transfer structure through at least one first via hole;
wherein an orthographic projection of the first connecting line on the base substrate overlaps at least partially with the orthographic projection of the first transfer structure on the base substrate, and the first connecting line is electrically connected to the first transfer structure in an overlapping region of the first connecting line and the first transfer structure through at least one second via hole; and
wherein an orthographic projection of the first welding structure on the base substrate overlaps partially with the orthographic projection of the first connecting portion on the base substrate, an orthographic projection of the signal line body on the base substrate and the orthographic projection of the first connecting line on the base substrate, and the first welding structure is configured to weld the first connecting portion, the signal line body and the first connecting line together in an overlapping region of the first welding structure, the first connecting portion, the signal line body and the first connecting line.

4. The display substrate according to claim 3, wherein the first connecting line comprises a second connecting portion and a connecting line body, an orthographic projection of the second connecting portion on the base substrate overlaps at least partially with the orthographic projection of the first transfer structure on the base substrate, and the second connecting portion is electrically connected to the first transfer structure in an overlapping region of the second connecting portion and the first transfer structure through the second via hole; and
wherein the first welding structure comprises:
a first welding portion, an orthographic projection of the first welding portion on the base substrate overlaps partially with the orthographic projection of the first connecting portion on the base substrate and an orthographic projection of the second connecting portion on the base substrate, and the first welding portion is configured to weld the first connecting portion and the second connecting portion together in an overlapping region of the first welding portion, the first connecting portion and the second connecting portion; and/or
a second welding portion, an orthographic projection of the second welding portion on the base substrate overlaps partially with the orthographic projection of the signal line body on the base substrate and an orthographic projection of the connecting line body on the base substrate, and the second welding portion is configured to weld the signal line body and the connecting line body together in an overlapping region of the second welding portion, the signal line body and the connecting line body.

5. The display substrate according to claim 4, wherein the orthographic projection of the first welding portion on the base substrate and the orthographic projection of the second welding portion on the base substrate are located on a same side of the orthographic projection of the second connecting portion on the base substrate, and are spaced apart from each other.

6. The display substrate according to claim 3, wherein the display substrate further comprises a second transfer structure in the third conductive layer, and the initiation signal lead is located in the first conductive layer;
wherein the initiation signal lead comprises a third connecting portion and a lead body, an orthographic projection of the third connecting portion on the base substrate overlaps at least partially with an orthographic projection of the second transfer structure on the base substrate, and the third connecting portion is electrically connected to the second transfer structure in an overlapping region of the third connecting portion and the second transfer structure through at least one third via hole;
wherein the orthographic projection of the first connecting line on the base substrate overlaps at least partially with the orthographic projection of the second transfer structure on the base substrate, and the first connecting line is electrically connected to the second transfer structure in an overlapping region of the first connecting line and the second transfer structure through at least one fourth via hole; and
wherein an orthographic projection of the second welding structure on the base substrate overlaps partially with an orthographic projection of a second connecting portion on the base substrate, an orthographic projection of the lead body on the base substrate and the orthographic projection of the first connecting line on the base substrate, and the second welding structure is configured to weld the second connecting portion, the lead body and the first connecting line together in an overlapping region of the second welding structure, the second connecting portion, the lead body and the first connecting line.

7. The display substrate according to claim 6, wherein the first connecting line further comprises a fourth connecting portion and a connecting line body, an orthographic projection of the fourth connecting portion on the base substrate overlaps at least partially with the orthographic projection of the second transfer structure on the base substrate, and the fourth connecting portion is electrically connected to the second transfer structure in an overlapping region of the fourth connecting portion and the second transfer structure; and
wherein the second welding structure comprises:
a third welding portion, an orthographic projection of the third welding portion on the base substrate overlaps partially with the orthographic projection of the third connecting portion on the base substrate and an orthographic projection of the fourth connecting portion on the base substrate, and the third welding portion is configured to weld the third connecting portion and the fourth connecting portion together in an overlapping region of the third welding portion, the third connecting portion and the fourth connecting portion; and/or
a fourth welding portion, an orthographic projection of the fourth welding portion on the base substrate overlaps partially with the orthographic projection of the lead body on the base substrate and an orthographic projection of the connecting line body on the base substrate, and the fourth welding portion is configured to weld the lead body and the connecting line body together in an overlapping region of the fourth welding portion, the lead body and the connecting line body.

8. The display substrate according to claim 7, wherein the orthographic projection of the third welding portion on the base substrate and the orthographic projection of the fourth welding portion on the base substrate are located on different sides of the orthographic projection of the third connecting portion on the base substrate, and are spaced apart from each other.

9. The display substrate according to claim 2, wherein a material of the first welding structure and the second welding structure comprises a solid welding material, the first welding structure is configured to weld the initiation signal line and the first connecting line together through at least one first welding hole, the second welding structure is configured to weld the initiation signal lead and the first connecting line together through at least one second welding hole, and a hole diameter of the at least one first welding hole and a hole diameter of the at least one second welding hole are less than or equal to a line width of the first connecting line.

10. The display substrate according to claim 9, wherein an orthographic projection of the at least one first welding hole on the base substrate and an orthographic projection of the at least one second welding hole on the base substrate overlap at least partially with an orthographic projection of the first connecting line on the base substrate.

11. The display substrate according to claim 2, wherein a material of the first welding structure and the second welding structure comprises a solid welding material or a liquid welding material, the first welding structure is configured to weld the initiation signal line and the first connecting line together through a third welding hole, the second welding structure is configured to weld the initiation signal lead and the first connecting line together through a fourth welding hole, and a hole diameter of the third welding hole and a hole diameter of the fourth welding hole are greater than a line width of the first connecting line.

12. The display substrate according to claim 11, wherein an orthographic projection of the third welding hole on the base substrate and an orthographic projection of the fourth welding hole on the base substrate are spaced apart from an orthographic projection of the first connecting line on the base substrate.

13. The display substrate according to claim 11, wherein at least one of the first welding structure and the second welding structure is in contact with a surface of the first connecting line on a side away from the base substrate.

14. The display substrate according to claim 1, wherein the display substrate further comprises:
a plurality of third connecting lines and at least one fourth connecting line that are provided on the base substrate and located in the side region;
wherein the plurality of third connecting lines extend in the second direction, the at least one fourth connecting line extends in the first direction, and the plurality of third connecting lines are located on a side of the gate driving circuit away from the initiation signal lead;
wherein at least one stage of shift register unit comprises a first input terminal, the first input terminals of first N stages of shift register units are electrically connected to the plurality of third connecting lines, and the first input terminals of different stages of shift register units are electrically connected to different third connecting lines; and
wherein the initiation signal line is electrically connected to the plurality of third connecting lines through the at least one fourth connecting line, where N is a positive integer.

15. The display substrate according to claim 14, wherein the anti-static structure in the second position comprises a partition structure, and a portion of the plurality of first signal lines on a side of the partition structure close to the binding opposite region is spaced apart from a portion of the plurality of first signal lines on a side of the partition structure close to the binding region by the partition structure;
wherein the initiation signal lead is welded with the at least one fourth connecting line through a third welding structure, and the at least one fourth connecting line is welded with the plurality of third connecting lines through a fourth welding structure; and
wherein the partition structure, the third welding structure and the fourth welding structure are within a predetermined range.

16. The display substrate according to claim 15, wherein the display substrate further comprises a sealant on the base substrate, an orthographic projection of the partition structure on the base substrate is located in the side region, and an orthographic projection of the sealant on the base substrate covers the orthographic projection of the partition structure on the base substrate.

17. The display substrate according to claim 15, wherein the display substrate further comprises a plurality of invalid shift register units, and in the second direction, the plurality of invalid shift register units are located on a side of the gate driving circuit close to the binding opposite region; and
wherein the partition structure, the third welding structure and the fourth welding structure are located between two invalid shift register units adjacent in the second direction.

18. A display motherboard, comprising a first substrate region and a second substrate region, wherein the first substrate region is configured to manufacture the display substrate according to claim 1;
wherein the first substrate region and the second substrate region have different sizes in a third direction, and the second substrate region comprises a first sub-region and a second sub-region at least partially surrounding the first sub-region;
wherein the first substrate region comprises a fourth conductive layer, the second substrate region comprises a fifth conductive layer, and the fourth conductive layer and the fifth conductive layer are arranged in the same layer and made of the same material; and
wherein a pattern of the fourth conductive layer is the same as a pattern of a portion of the fifth conductive layer located in the first sub-region.

19. A display panel, comprising the display substrate according to claim 1.

20. A display device, comprising the display panel according to claim 19.
